(19) United States
(12) Patent Application Publication
(10) Pub. No.: US 2025/0227627 A1
(43) Pub. Date: Jul. 10, 2025

(54) TECHNIQUES FOR REPORTING MULTIPLE PARAMETER VALUES IN POWER HEADROOM REPORT

(71) Applicant: QUALCOMM Incorporated, San Diego, CA (US)

(72) Inventors: Fang YUAN, Beijing (CN); Ruiming ZHENG, Beijing (CN); Yan ZHOU, San Diego, CA (US); Ozcan OZTURK, San Diego, CA (US); Linhai HE, San Diego, CA (US); Tao LUO, San Diego, CA (US)

(21) Appl. No.: 18/729,264

(22) PCT Filed: Mar. 15, 2022
(86) PCT No.: PCT/CN2022/080865

§ 371 Date: Jul. 16, 2024

(51) Int. Cl. H04W 52/36; H04W 72/21

(52) U.S. Cl. CPC H04W 52/365; H04W 72/21

(57) ABSTRACT

Various aspects of the present disclosure generally relate to wireless communication. In some aspects, a user equipment (UE) may receive a maximum permitted exposure (MPE) reporting configuration. The UE may transmit, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs. Numerous other aspects are described.

### FIELD OF THE DISCLOSURE

Aspects of the present disclosure generally relate to wireless communication and to techniques and apparatuses for reporting multiple parameter values in a power headroom report.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a maximum permitted exposure (MPE) reporting configuration. The method may include transmitting, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

Some aspects described herein relate to a method of wireless communication performed by a network node. The method may include transmitting a MPE reporting configuration. The method may include receiving, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

Some aspects described herein relate to a UE for wireless communication. The user equipment may include a memory and one or more processors coupled to the memory. The one or more processors may be configured to receive a MPE reporting configuration. The one or more processors may be configured to transmit, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

Some aspects described herein relate to a network node for wireless communication. The network node may include a memory and one or more processors coupled to the memory. The one or more processors may be configured to transmit a MPE reporting configuration. The one or more processors may be configured to receive, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

Some aspects described herein relate to a non-transitory computer-readable medium that stores a set of instructions for wireless communication by a UE. The set of instructions, when executed by one or more processors of the UE, may cause the UE to receive a MPE reporting configuration. The set of instructions, when executed by one or more processors of the UE, may cause the UE to transmit, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

Some aspects described herein relate to a non-transitory computer-readable medium that stores a set of instructions for wireless communication by a network node. The set of instructions, when executed by one or more processors of the network node, may cause the network node to transmit a MPE reporting configuration. The set of instructions, when executed by one or more processors of the network node, may cause the network node to receive, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

Some aspects described herein relate to an apparatus for wireless communication. The apparatus may include means for receiving a MPE reporting configuration. The apparatus may include means for transmitting, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

Some aspects described herein relate to an apparatus for wireless communication. The apparatus may include means for transmitting a MPE reporting configuration. The apparatus may include means for receiving, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network architecture, in accordance with the present disclosure.

FIG. 4 is a diagram illustrating an example of single-cell maximum permitted exposure (MPE) reporting using a power headroom report (PHR) of a medium access control (MAC) control element (MAC CE), in accordance with the present disclosure.

FIG. 5 is a diagram illustrating examples of MPE reports for multi-cell, single-panel PHR reporting, in accordance with the present disclosure.

FIG. 6 is a diagram illustrating an example associated with reporting multiple parameter values in a power headroom report, in accordance with the present disclosure.

FIGS. 7-14 are diagrams illustrating examples of configurations of MAC CEs having PHRs, in accordance with the present disclosure.

FIGS. 15 and 16 are diagrams illustrating example processes associated with reporting multiple parameter values in a power headroom report, in accordance with the present disclosure.

FIGS. 17 and 18 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

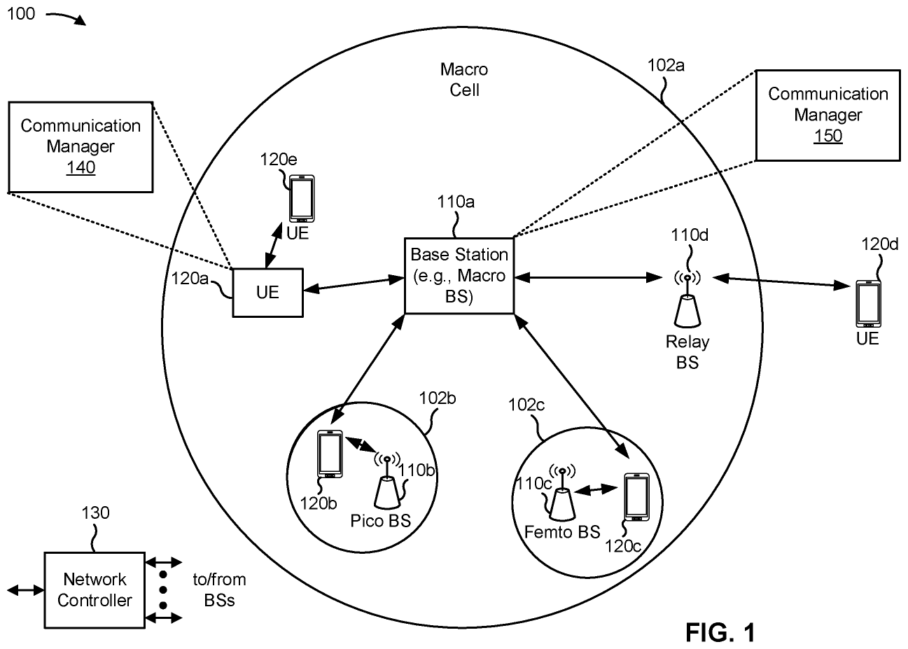

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described herein, a network node, which may be referred to as a “node,” a “network node,” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, a UE 120 may include a communication manager 140. As described in more detail elsewhere herein, the communication manager 140 may receive a maximum permitted exposure (MPE) reporting configuration; and transmit, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs. Additionally, or alternatively, the communication manager 140 may perform one or more other operations described herein.

In some aspects, a network node may include a communication manager 140 or a communication manager 150. As described in more detail elsewhere herein, the communication manager 140 or 150 may transmit a MPE reporting configuration; and receive, based at least in part on the MPE reporting configuration, a MAC CE that includes a PHR corresponding to an activated component carrier, the PHR comprising at least one MPE reporting indication that that indicates at least one MPE value, and at least one additional reporting indication that indicates a number of resource IDs reported in the PHR and a number of additional MPE values reported in the PHR, wherein the additional MPE values are associated with the resource IDs. Additionally, or alternatively, the communication managers 140 or 150 may perform one or more other operations described herein.

As indicated above, FIG. 1 is provided as an example. Other examples may differ from what is described with regard to FIG. 1.

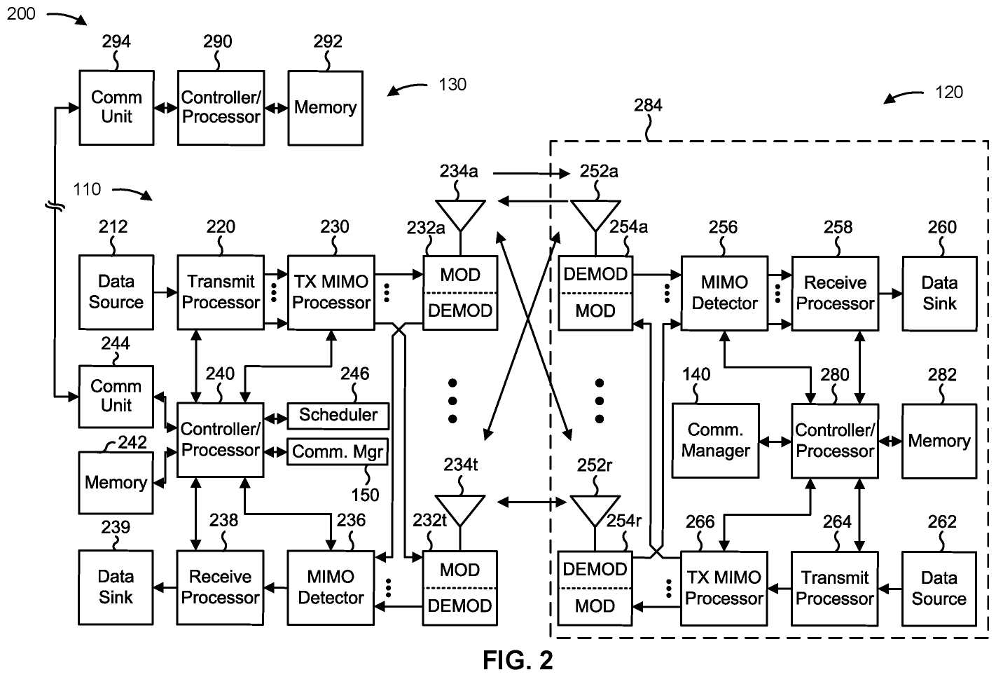

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “base station” (e.g., the base station 110), “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

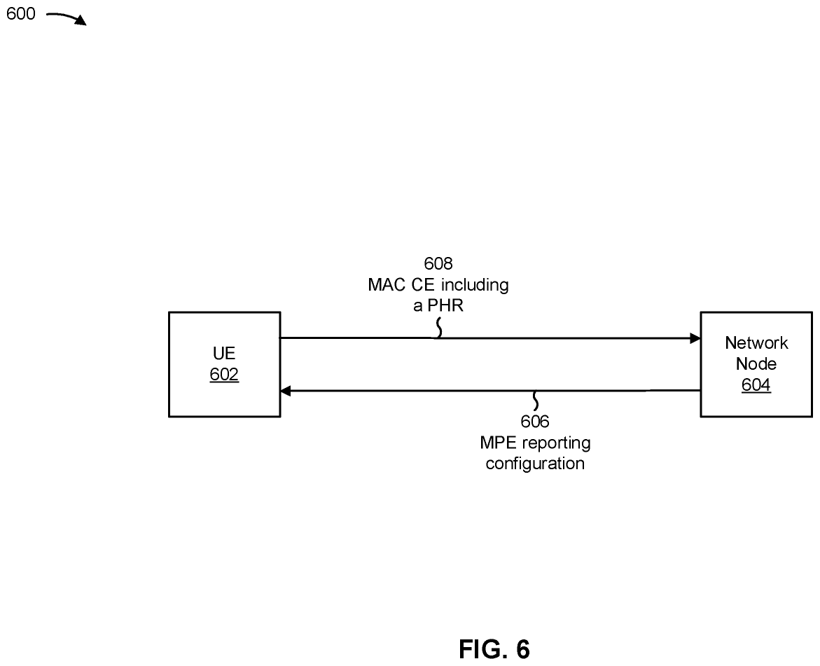

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-18).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-18).

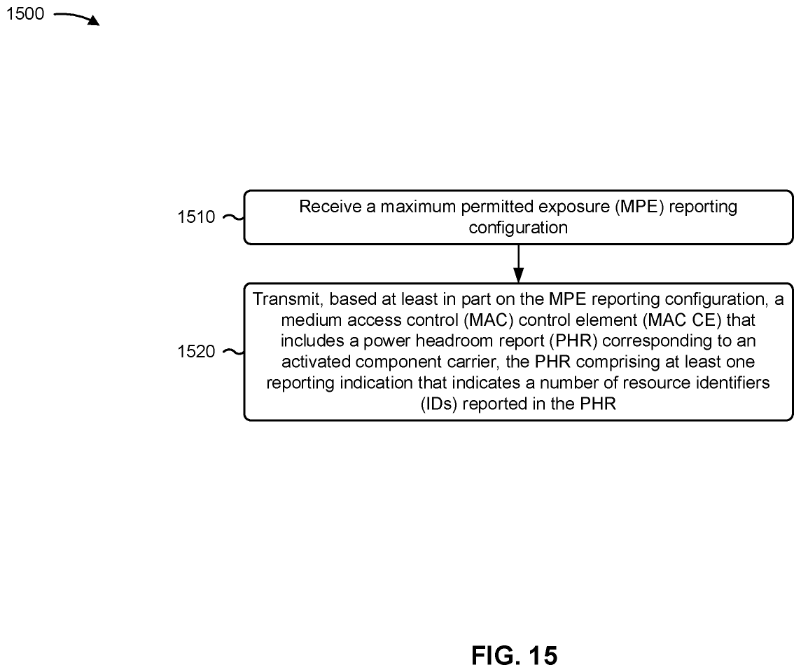

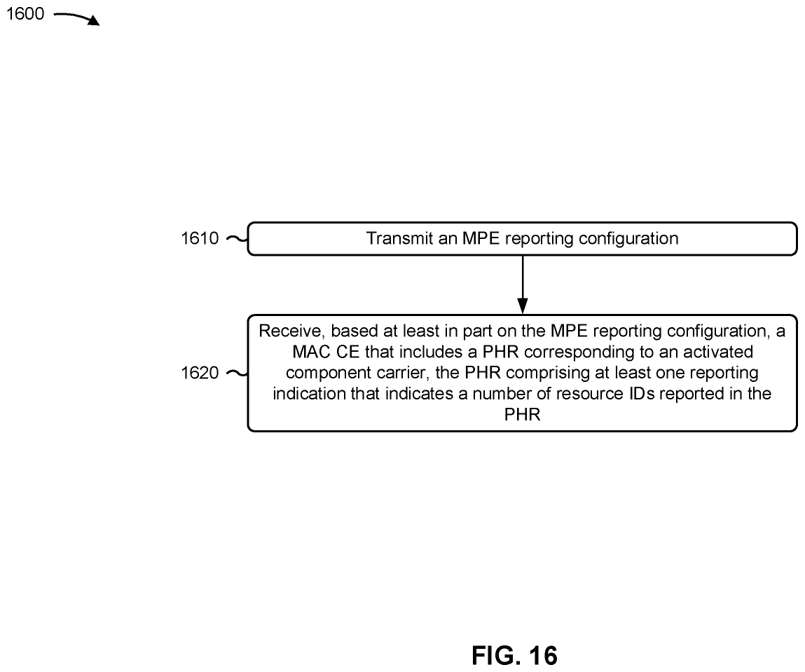

The controller/processor 240 of the base station 110, the controller/processor 280 of the UE 120, and/or any other component(s) of FIG. 2 may perform one or more techniques associated with reporting multiple parameter values in a PHR, as described in more detail elsewhere herein. In some aspects, the network node described herein is the base station 110, is included in the base station 110, or includes one or more components of the base station 110 shown in FIG. 2. In some aspects, the network node described herein is the UE 120, is included in the UE 120, or includes one or more components of the UE 120 shown in FIG. 2. For example, the controller/processor 240 of the base station 110, the controller/processor 280 of the UE 120, and/or any other component(s) of FIG. 2 may perform or direct operations of, for example, process 1500 of FIG. 15, process 1600 of FIG. 16, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1500 of FIG. 15, process 1600 of FIG. 16, and/or other processes as described herein. In some examples, executing instructions may include running the instructions, converting the instructions, compiling the instructions, and/or interpreting the instructions, among other examples.

In some aspects, a UE includes means for receiving a MPE reporting configuration; and/or means for transmitting, based at least in part on the MPE reporting configuration, a MAC CE that includes a PHR corresponding to an activated component carrier, the PHR comprising at least one MPE reporting indication that that indicates at least one MPE value, and at least one additional reporting indication that indicates a number of resource IDs reported in the PHR and a number of additional MPE values reported in the PHR, wherein the additional MPE values are associated with the resource IDs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node includes means for transmitting a MPE reporting configuration; and/or means for receiving, based at least in part on the MPE reporting configuration, a MAC CE that includes a PHR corresponding to an activated component carrier, the PHR comprising at least one MPE reporting indication that that indicates at least one MPE value, and at least one additional reporting indication that indicates a number of resource IDs reported in the PHR and a number of additional MPE values reported in the PHR, wherein the additional MPE values are associated with the resource IDs. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the network node to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

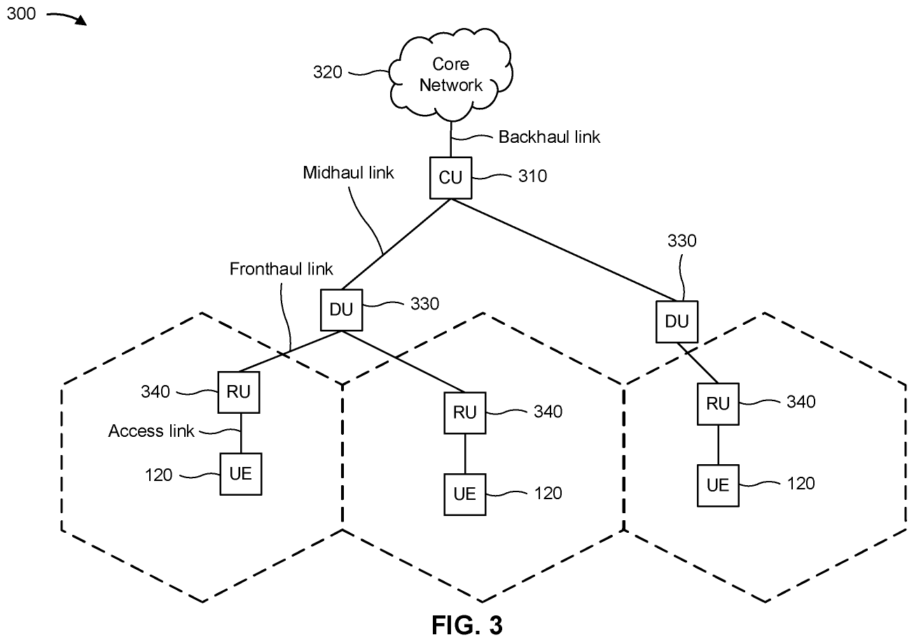

FIG. 3 is a diagram illustrating an example 300 of an O-RAN architecture, in accordance with the present disclosure. As shown in FIG. 3, the O-RAN architecture may include a control unit (CU) 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via radio frequency (RF) access links. The DUs 330 and the RUs 340 may also be referred to as O-RAN DUs (O-DUs) 330 and O-RAN RUS (O-RUS) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

Because UEs can emit RF waves, microwaves, and/or other radiation, UEs are generally subject to regulatory RF safety requirements that set forth specific guidelines, or MPE limits, that constrain various operations that the UEs can perform. For example, RF emissions can generally increase when a UE is transmitting, and the RF emissions can further increase in cases where the UE is performing frequent transmissions and/or high-power transmissions, among other examples. Accordingly, because frequent and/or high-power transmission can lead to significant RF emissions, regulatory agencies (e.g., the Federal Communications Commission (FCC) in the United States) provide information related to acceptable RF radiation exposure when UEs are communicating using different radio access technologies.

For example, when a UE is communicating using radio access technologies that operate in a frequency range below 6 GHZ, the applicable RF exposure parameter is a specific absorption rate (SAR), which refers to a rate at which the human body absorbs energy when exposed to RF energy (e.g., power absorbed per unit of mass, which can be expressed according to watts per kilogram (W/kg)). SAR requirements generally specify that overall radiated power by a UE is to remain under a certain level to limit heating that can occur when RF energy is absorbed. In another example, when a UE is communicating using a radio access technology that operates in a high frequency range, such as a millimeter wave (mmW) frequency range, the applicable RF exposure parameter is power density, which can be regulated to limit heating of the UE and/or nearby surfaces.

Accordingly, UEs can take measures to satisfy MPE limits, which are typically regulatory requirements that are defined in terms of aggregate exposure over a certain amount of time, and the aggregate exposure can be averaged over a moving integration window (or moving time window). For example, a UE can be subject to an average power limit (Pₗᵢₘᵢₜ) that corresponds to an average power at which an MPE limit is satisfied if the UE were to transmit substantially continuously over a moving integration window of N seconds (e.g., 100 seconds). In some cases, a UE can satisfy the MPE limits by applying a power management-maximum power reduction (P-MPR) to reduce the transmission power. The P-MPR can refer to a maximum allowed UE output power reduction for a serving cell. In some aspects, a UE reports a power back off level due to the P-MPR as an MPE value.

The UE can report the P-MPR to a network node to facilitate efficient communication. The P-MPR can be reported as part of a PHR, which can be reported using a PHR MAC CE. For example, a PHR MAC CE can be a MAC CE that is enhanced to report P-MPR information. In some cases, a two-bit MPE field can be provided by reusing reserve bits to indicate the applied power backoff to meet an MPE requirement.

P-MPR reporting can be event triggered based on the P-MPR exceeding a network configured threshold (e.g., an absolute P-MPR value, which can be specified using a parameter mpe-Threshold). In some cases, P-MPR reporting can be triggered if at least one serving cell handled by a MAC entity of the UE has a corresponding P-MPR that exceeds the threshold. The same threshold value can apply to each serving cell.

The PHR report also can report a PHR value, which can correspond to a difference between an actual transmit power at which the UE is operating and the maximum configured power. PHR reporting can be triggered when power backoff due to P-MPR for a cell has changed more than a threshold since the last transmission of a PHR. That threshold can be specified as a parameter phr-Tx-PowerFactorChange.

In accordance with some enhancements to facilitate MPE mitigation, for event triggered P-MPR-based reporting, in addition to the existing field in the PHR MAC-CE, N≥1 P-MPR values can be reported. The N P-MPR values can be reported together with resource IDs. For example, for each P-MPR value, one or more (e.g., up to M) synchronization signal block (SSB) resource indicators (RIs) and/or channel state information (CSI)-reference signal (CSI-RS) RIs (CRIs) can be reported. The one or more SSBRIs and/or CRIs can be selected by the UE from a candidate SSB/CSI-RS resource pool.

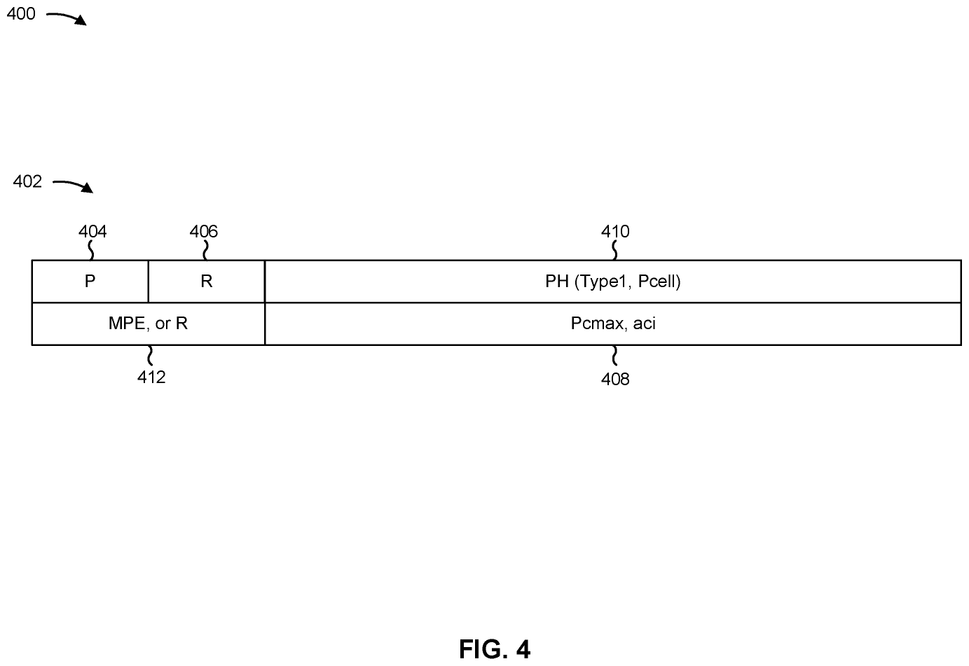

In some cases, a legacy PHR MAC CE can be used for single-cell reporting. FIG. 4 is a diagram illustrating an example 400 of single-cell MPE reporting using a PHR 402 of a MAC CE, in accordance with the present disclosure. As shown, the PHR 402 can include a power backoff indication field (referred to as a “P field” or a “P bit”) 404 that can be used to indicate a power backoff applied due to power management. In some cases, the P field 404 can be used to indicate reporting of a measured value of a P-MPR. For example, the P field can be set to a specified value (e.g., 1) if P-MPR levels are being reported, in which case the P-MPR values can be reported. If the P-MPR levels are not to be reported (e.g., if the power backoff is less than a specified value), the P field can be set to a different specified value (e.g., 0) and reserve bits (shown as “R”) 406 can be presented. In some cases, if MPE reporting is not configured, P=1 if the corresponding P_{CMAX,f,c} field 408 would have had a different value if no power backoff due to power management had been applied. The P_{CMAX}_{_{,f,c}} field 408 may include a value of P_{CMAX}_{_{f,c}} that may represent a UE configured maximum output power after backoff due to power management (e.g., backoff due to a maximum power reduction) with respect to a carrier f of serving cell c. The PHR 402 also includes a power headroom (PH) field 410 that indicates the power headroom level. The P_{CMAX}_{_{f,c}} field 408 can be used for calculating a preceding PH field. The PHR 402 also includes an MPE field 412. If MPE reporting is configured, and if the P field 404 is set to 1, the MPE field 412 indicates the applied power backoff to meet MPE requirements. The MPE field 412 indicates an index of the corresponding measured values of P-MPR levels in decibels (dB). If MPE reporting is not configured, or if the P field is set to 0, R bits are present instead.

As indicated above, FIG. 4 is provided as an example. Other examples may differ from what is described with regard to FIG. 4.

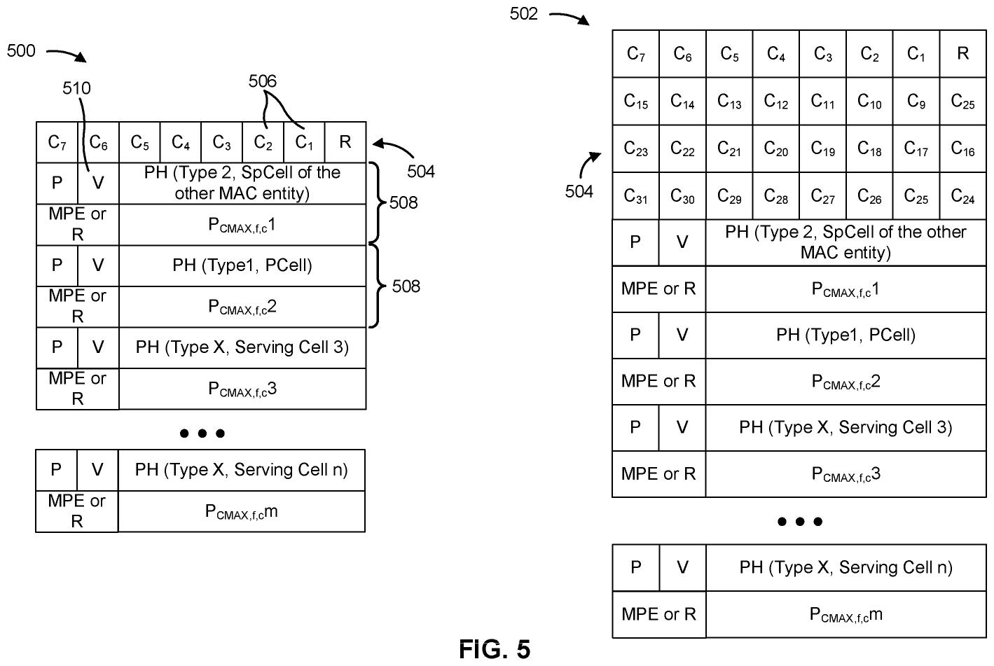

A UE may be configured with multiple component carriers for an uplink transmission. FIG. 5 is a diagram illustrating examples 500 and 502 of MPE reports for multi-cell, single-panel PHR reporting. As shown, an MPE report can include a bitmap 504 including cell activation status fields 506. Each cell activation status field 506 indicates a serving cell index, Cᵢ (shown as “C₁,” C₂,” . . . ). The cell activation status fields (known as “C fields”) 506 can indicate a serving cell and/or component carrier corresponding to a PHR 508 that is being reported.

A PHR MAC-CE can include a PHR for more than one component carrier when a multiplePHR parameter is enabled via radio resource control (RRC) signaling. Otherwise, the PHR can be a report for a primary cell (PCell) and a single-entry PHR MAC-CE format may be used. When a first uplink channel in a first component carrier carries the PHR MAC-CE, for a second component carrier, the PHR MAC-CE can include an actual PHR 508 or a virtual PHR (based on a reference format). Each PHR 508 can include a virtual PHR indication field 510 that indicates whether the corresponding PH value is based on a real transmission or a reference format. When an uplink transmission is performed on the second component carrier at a time of power headroom reporting (e.g., in a slot of the first uplink transmission), and the uplink transmission on the second component carrier is scheduled by downlink control information (DCI) that satisfies a timeline condition, the PHR MAC-CE can include the actual PHR. Otherwise, the MAC-CE can include the virtual PHR. For a virtual PHR, the P_{CMAX} is not reported.

The MPE reporting described above can suffer from inefficiencies in the context of UEs equipped with multiple antenna panels and configured to communicate using MIMO techniques and/or UEs equipped to communicate via multiple component carriers. In such cases, a UE can include multiple antenna panels, each having a set of antenna ports that facilitate generating one or more beams. By reporting MPE information (e.g., P-MPR values or MPE values) per serving cell, differences in MPE information that can exist for one beam, port, and/or panel versus another beam, port and/or panel can be overlooked. As a result, MPE information overreporting and/or underreporting can occur, thereby decreasing network efficiencies and/or network performance.

Some aspects described herein relate to techniques and apparatuses to provide, to a network node, a MAC CE that includes a PHR corresponding to an activated component carrier, where the PHR includes at least one MPE reporting indication. The PHR also may include at least one additional MPE reporting indication that indicates a number of resource IDs and associated P-MPR values (e.g., MPE values) reported in the PHR. The resource IDs may indicate beams associated with the P-MPR values. For example, in some aspects, the PHR may include a plurality of fields indicating one or more sets of parameter values. A set of parameter values may include a P-MPR value and a resource ID associated with the P-MPR value. The at least one additional MPE reporting indication may include at least one set of parameters, a P-field, a combination of values of multiple fields, and/or a dedicated indication field. In this way, by providing a component carrier-specific UE report to the network node that indicates the uplink energy budget available to the UE, including resource IDs that may identify corresponding beams, the network node may schedule the UE more efficiently, which improves performances, and/or conserves network resources that may otherwise be wasted reestablishing a connection that was dropped because the UE reduced the uplink transmit power more than necessary, among other examples. Some aspects include efficient MAC CE structures for reporting the resource IDs and for indicating the number of resource IDs reported, thereby saving overhead. As a result, some aspects may increase network efficiency and/or enhance overall performance, thereby having a positive impact on network performance.

As indicated above, FIG. 5 is provided as an example. Other examples may differ from what is described with regard to FIG. 5.

FIG. 6 is a diagram illustrating an example 600 associated with reporting multiple parameter values in a PHR, in accordance with the present disclosure. As shown, a UE 602 and a network node 604 may communicate with one another. The UE 602 may be, be similar to, include, or be included in, the UE 120 depicted in FIGS. 1-3. The network node 604 may be, be similar to, include, or be included in, the base station 110 depicted in FIGS. 1 and 2, the CU 310 depicted in FIG. 3, the DU 330 depicted in FIG. 3, the RU 340 depicted in FIG. 3, and/or the UE 120 depicted in FIGS. 1-3.

As shown by reference number 606, the network node 604 may transmit, and the UE 602 may receive, an MPE reporting configuration. In some aspects, the MPE reporting configuration may be transmitted using an RRC message. The MPE reporting configuration may indicate a set of parameters to be reported. The MPE reporting configuration may indicate one or more aspects associated with reporting MPE information. For example, the MPE reporting configuration may indicate resources to be used for reporting MPE information, one or more parameters to be reported, formats associated with reporting MPE information, one or more MAC CE configurations to be used for reporting MPE information, trigger conditions for reporting MPE information, and/or a prohibition timer to facilitate avoiding reporting MPE information too often, among other examples.

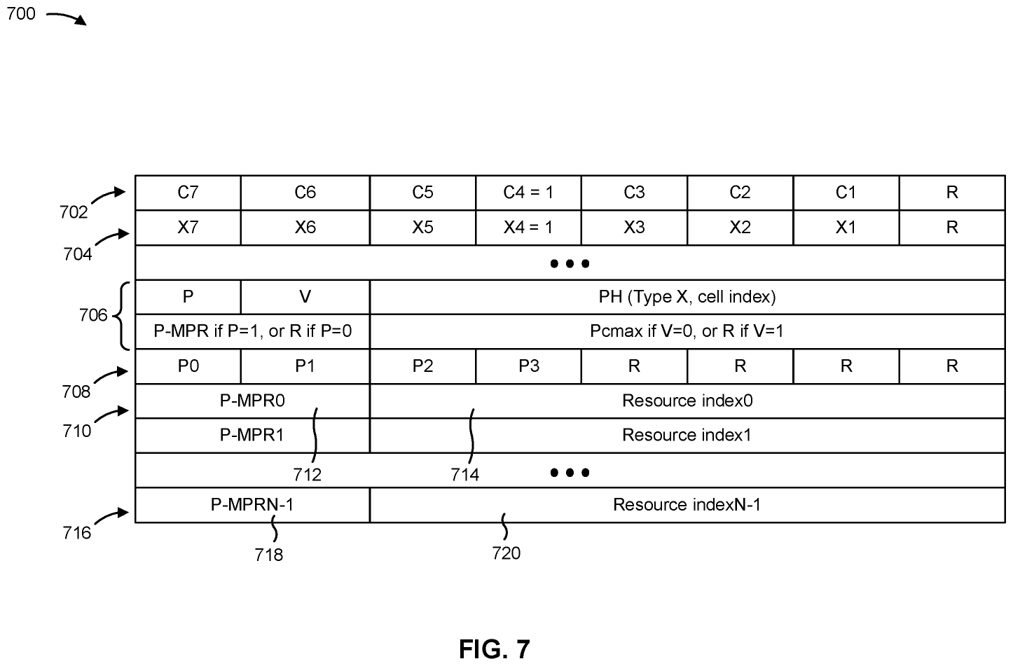

As shown by reference number 608, the UE 602 may transmit, and the network node 604 may receive, a MAC CE that includes a PHR corresponding to an activated component carrier. For example, the PHR for an activated component carrier may include a legacy PHR report, which may include at least one MPE reporting indication. The at least one reporting indication may include a P field, a virtual indicator field (a “V field”) that indicates whether a PH value is based on a real transmission or a reference format, a reserved field (“R field”), an MPE field, and/or a Pcmax field (as shown by reference number 706 in FIG. 7). The UE 602 may transmit the MAC CE based at least in part on the MPE reporting configuration. The PHR may include at least one MPE reporting indication at least one additional MPE reporting indication that indicates a number of resource IDs and P-MPR values reported in the PHR. The PHR may include a plurality of fields indicating one or more (up to N, based on pre-configuration) sets of parameter values, where a set of parameter values may include a P bit, a P-MPR value, and an associated resource ID. For example, the P bit parameter may be used to indicate whether a power back off due to power management-maximum power reduction is larger than a predetermined threshold, the P-MPR parameter may be used to indicate a power back off level (e.g., the MPE value) due to power management-maximum power reduction, and the resource ID parameter (e.g., RS ID or resource index) may be used to indicate the resource index associated with the P bit and the P-MPR value. For example, the P bit parameter may be reported as 1 bit, the P-MPR parameter may be reported as 2 bits, and the resource ID may be reported as 6 bits. In some aspects, in a set of parameter values, the UE 602 may report a P-MPR value only when the P-bit is indicated as a specified value (sometimes referred to as a “special value”) (e.g., 1), otherwise the field for the P-MPR value may be reserved or not present.

In some aspects, the at least one additional reporting indication may include a power backoff indication (Pn, e.g., a P field for the nth set of parameter values), of a set of power backoff indications {P1, . . . , Pn}, where n={0, 1, . . . , N−1}, and the maximum value of N may be 1, 2,3, or 4, and may be configured by higher layer signaling such as RRC signaling. In some aspects, the power backoff indication may correspond to a P-MPR value of a set of P-MPR values, {P-MPR0, P-MPR1, . . . , P-MPRN−1}. In some aspects, if Pn is indicated as a specified value, the nth resource ID and/or the value of P-MPRn is not reported in the nth set of parameter values. For example, a value of the power backoff indication may include a first specified value of a plurality of specified values (e.g., 0 and 1), and the PHR may not include a resource ID and a P-MPR value corresponding to the power backoff indication based at least in part on the value of the power backoff indication being the first specified value. In some aspects, the power backoff indication may correspond to a first index value of a set of index values associated with the one or more sets of parameter values, and the PHR, based at least in part on the value of the power backoff indication being the first specified value, may not include a resource ID and a P-MPR value corresponding to a second index value, of the set of index values, that is greater than the first index value. In some aspects, the first specified value may be 0, 1, and/or any other value.

In some aspects, a value of the power backoff indication may be a second specified value (e.g., 1) of the plurality of specified values, and the PHR may include a resource ID and a P-MPR value corresponding to the power backoff indication based at least in part on the value of the power backoff indication being the second specified value. The PHR may indicate a power backoff indication vector including the power backoff indication, and a number of power backoff indications in the power backoff indication vector may indicate the number of resource IDs and P-MPR values reported in the PHR. For example, when a P-bit Pn corresponding to the nth set of parameter values is set as 0 in the power backoff indication vector, a UE may not report a P-MPR value or a resource ID for the corresponding set, and when a P-bit Pn corresponding to the nth set of parameter values is set as 1 in the power backoff indication vector, a UE may report a P-MPR value and a resource ID for the corresponding set.

In some aspects, if a pair of values of {Pn, P-MPRn} is indicated as a combination of specified values, the nth resource ID and resource IDs having indexes equal to and/or greater than n are not reported. For example, in some aspects, the at least one MPE reporting indication may include an indication pair of a set of indication pairs. The indication pair may include a power backoff indication (e.g., P bit) and a P-MPR value. In some aspects, a value pair of the indication pair may include a combination of a first specified value, of a first plurality of specified values, and a second specified value, of a second plurality of specified values. The PHR may not include a resource ID corresponding to the P-MPR value based at least in part on the value pair being the combination of the first specified value and the second specified value. In some aspects, the value pair may correspond to a first index value of a set of index values associated with the one or more sets of parameter values, and the PHR, based at least in part on the value pair not being a combination of the first specified value and the second specified value, may not include a resource ID corresponding to a second index value, of the set of index values, that is greater than the first index value.

In some aspects, a value pair of the indication pair may be a combination of a first value that is not a first specified value of a first plurality of specified values, and a second value that is not a second specified value of a second plurality of specified values. The PHR may include a resource ID corresponding to the P-MPR value based at least in part on the value pair not being a combination of the first specified value and the second specified value. A number of indication pairs in the set of indication pairs may indicate the number of resource IDs reported in the PHR. The number of resource IDs reported in the PHR may be one less than the number of indication pairs in the set of indication pairs.

In some aspects, if a dedicated indication field, that indicates a dedicated indication value, Tn, indicates a specified value (e.g., Tn=0), the nth P-MPR and the nth resource ID are not reported in the additional MPE reporting. For example, the at least one additional indication may include a value of a dedicated indication field. The dedicated indication field may correspond to a P-MPR value. In some aspects, a value of the dedicated indication field may be a first specified value of a plurality of specified values, and the PHR may not include a resource ID corresponding to the dedicated indication field based at least in part on the value of the dedicated indication field being the first specified value.

In some aspects, a value of the dedicated indication field may be a second specified value of the plurality of specified values, and the PHR may include a resource ID corresponding to the dedicated indication field value based at least in part on the value of the dedicated indication field being the second specified value. The PHR may indicate a dedicated indication vector including the value of the dedicated indication field, and a number of dedicated indications in the dedicated indication vector may indicate the number of resource IDs reported in the PHR.

As indicated above, FIG. 6 is provided as an example. Other examples may differ from what is described with regard to FIG. 6.

FIG. 7 is a diagram illustrating an example 700 of a MAC CE having a PHR, in accordance with the present disclosure. Example 700 is associated with aspects described above, in connection with FIG. 6, in which if Pn is indicated as a specified value, the nth resource index and the value of P-MPRn is not reported. In some aspects, if Pn is indicated as a specified value, the value of P-MPRn is not present while the nth resource index may be reported.

As shown, the MAC CE of example 700 includes a C field octet 702 indicating serving cell (and/or component carrier) indices. The MAC CE also includes an “X field” (e.g. the octet 704) where Xm in the X field may indicate whether additional MPE report is reported in the PHR for the mth serving cell, where m={0, 1, 2, . . . , M−1}, and M is the number of serving cells configured to the UE. In the example of FIG. 7, the value of M may be 8. For example, as shown, X4=1, which indicates the 4^{th} serving cell is reported with an additional MPE report in the PHR report, where the additional MPE report may include at least one set of parameter values including a P bit, a P-MPR value, and a resource ID. The MAC CE includes a conventional PHR report 706 for the 4^{th} serving cell and, below the conventional PHR report 706, includes an additional MPE report, which may have a power backoff indication vector of a P0 field, a P1 field, a P2, field and a P3 field (and reserved fields, R) in the P field octet 708.

Each of P0, P1, P2, and P3 may have a value of either 0 or 1. If Pn=0, the nth the value of P-MPRn or the nth resource ID (e.g., resource index n) is not reported. For example, as shown for the 4^{th} serving cell reported with additional MPE report in the PHR report, the MAC CE includes an octet 710 that includes a P-MPR0 field 712 for reporting a P-MPR having an index of 0, which corresponds to P0 and the 0^{th} resource ID associated with P-MPR0, reported in a resource index 0 field 714. The resource IDs may be reported via a 1:1 mapping from Pn (where Pn=1) to resource index n. Thus, in the illustrated example, if P0=1, then the resource ID corresponding to resource index0 and the P-MPR0 is reported and present; if P1=1, then the resource ID corresponding to resource index1 and P-MPR1 is reported and present; and so on. Similarly, if P0=0, then the resource ID corresponding to resource index0 or the value of P-MPR0 is not reported or not present; if P1=0, then the resource ID corresponding to resource index1 or the value of P-MPR1 is not reported or not present; and so on. The MAC CE may include a number of octets for reporting a number of resource IDs and P-MPRs. Accordingly, as shown, an octet 716 may include a P-MPR N−1 field 718 for reporting the (N−1)th P-MPR and a resource index N−1 field 720 for reporting the (N−1)th resource ID. In some aspects, the value assignments may be reversed or not present such that if Pn=0, the resource index n and/or the P-MPRn is not reported or not present, and if Pn=1, the resource index n and the P-MPRn and the P-MPRn is reported. When the resource index n and the P-MPRn is not reported, the corresponding octet may not be present in the MAC-CE.

As indicated above, FIG. 7 is provided as an example. Other examples may differ from what is described with regard to FIG. 7.

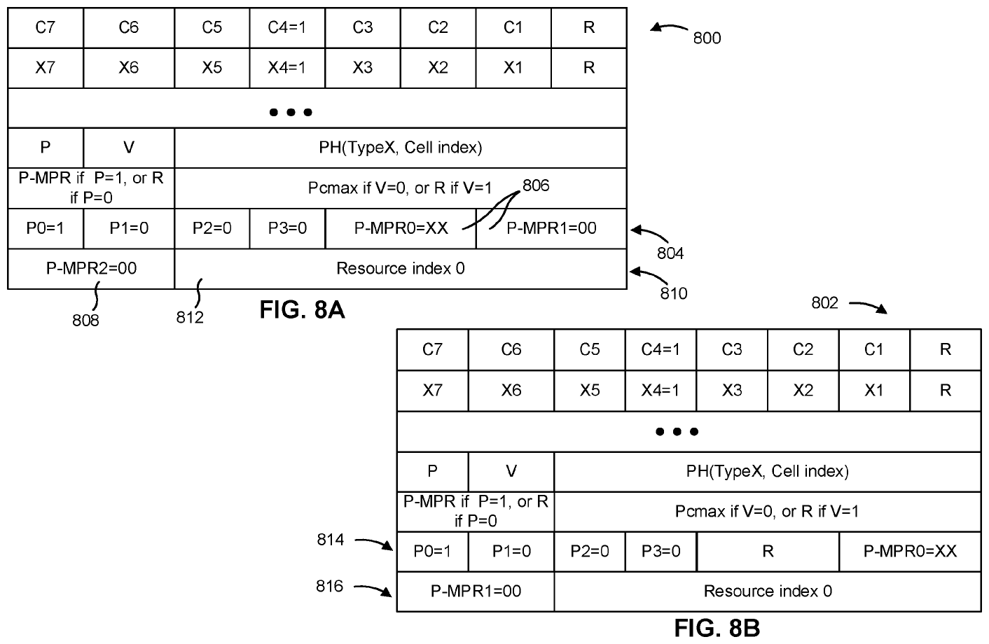

FIGS. 8A and 8B are diagrams illustrating examples 800 and 802 of a MAC CE having a PHR, in accordance with the present disclosure. Examples 800 and 802 are associated with aspects described above, in connection with FIG. 6, in which, if a pair of {Pn, P-MPRn} is indicated as a combination of specified values, the nth resource ID and resource IDs having indexes equal and greater than n are not reported. In some aspects, if a pair of {Pn, P-MPRn} is indicated as a combination of specified values, the UE may report a number of n sets of {P bit, P-MPR value, resource index} in the additional MPE report in the PHR for an activated serving cell. In examples 800 and 802, the UE reports a single reference signal (e.g., one beam is reported via a resource ID).

The MAC CEs depicted in FIGS. 8A and 8B may have more compact configurations than the MAC CE depicted in FIG. 7. As shown in FIG. 8A, for example, the octet 804 containing the P fields may include the number of P fields being reported and any remaining bits may be allocated to the first two P-MPR fields 806. The remaining P-MPR field 808 may be included in the octet 810 below the octet 804. The octet 810 also may include the resource index field 812 for the resource ID being reported.

As shown, in example 800, the cell index C4=1 indicates that there is a PHR reported for the 4^{th} serving cell, and the X field with X4=1, which indicates that for the 4^{th} serving cell there is an additional MPE report in the PHR. For example, if Pn=0 and P-MPRn=00, nth resource ID and onwards are not reported and, otherwise, at least the nth resource ID is reported. As shown in example 800, P0=1, and P-MPR0=xx, where xx is a reported value for P-MPR level. Accordingly, the resource ID corresponding to resource index0 is reported. However, since P1=0, and P-MPR1=00, there is no other P, P-MPR, or resource ID reported in the additional MPE report for the cell.

In this way, for example, the UE does not need to read any additional fields to those containing reported values. Thus, the MAC CE configuration in example 802 may be used, in which the P-MPR2 field is omitted. The P-MPR0 field may be shifted to the right within octet 814, leaving a field of reserve bits R in the octet 814, which may be left reserved or used for some other purpose. The P-MPR1 field and the resource index1 field may be included in the following octet 816, as shown.

As indicated above, FIGS. 8A and 8B are provided as examples. Other examples may differ from what is described with regard to FIGS. 8A and 8B. In some aspects, when the UE determines to report a single set of {P, P-MPR, and resource ID} for an additional MPE report in a PHR report for a serving cell, the UE may report the set of {P0, P-MPR0, resource ID0} in corresponding fields to indicate the additional MPE information, and also set the indication of {P1, P-MPR1} with a combination of specified values in corresponding fields to indicate that there is no further resource IDs and P-MPR values are reported in the additional MPE information for the serving cell. In some aspects, when the UE determines to report only a single set of {P, P-MPR, and resource ID} in an additional MPE report in a PHR report for a serving cell, the UE may report the set of {P0, P-MPR0, resource ID0} in corresponding fields to indicate the additional MPE information, and also set the indication of {P1=0, P-MPR1-00} with a combination of specified values in corresponding fields to indicate that there is no further resource IDs and P-MPR values are reported in the additional MPE information for the serving cell.

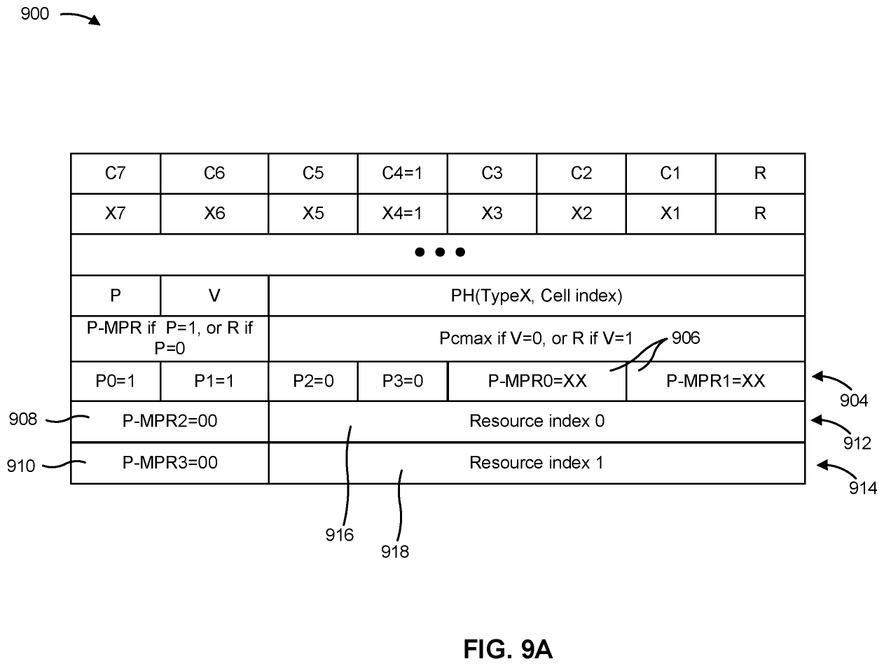

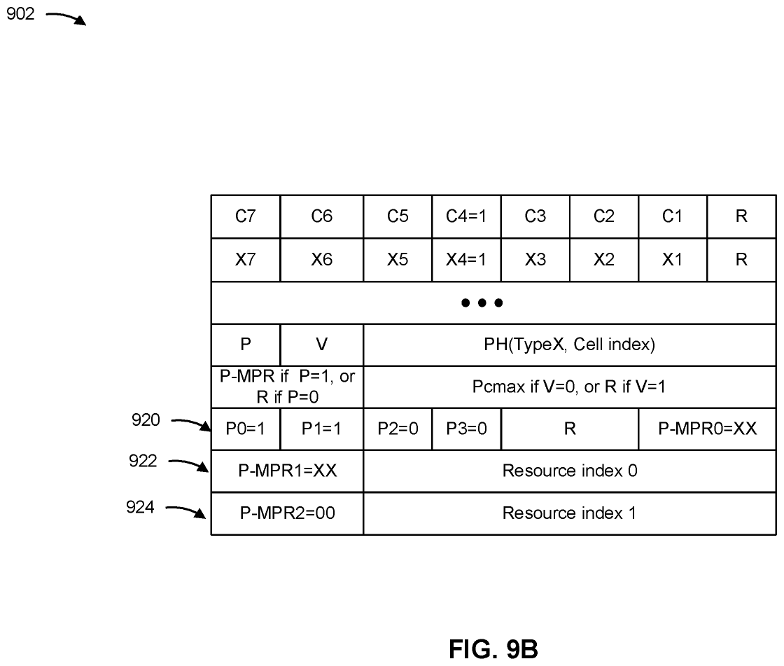

FIGS. 9A and 9B are diagrams illustrating examples 900 and 902 of a MAC CE having a PHR, in accordance with the present disclosure. Examples 900 and 902 also are associated with aspects described above, in connection with FIG. 6, in which, if a pair of {Pn, P-MPRn} is indicated as a combination of specified values, the nth resource ID and resource IDs having indexes greater than n are not reported, as in examples 800 and 802. In examples 900 and 902, the UE reports two reference signals (e.g., two beams are reported via two resource IDs).

As shown in FIG. 9A, for example, the octet 904 containing the P fields may include the number of P fields being reported and any remaining bits may be allocated to the first two P-MPR fields 906. The remaining P-MPR fields 908 and 910 reported may be included, respectively, in the octet 912 below the octet 904 and the octet 914, below the octet 912. The octets 912 and 914 also may include the resource index fields 916 and 918 for the resource IDs being reported, respectively. As shown, the cell index C4=1 indicating there is a PHR report reported for the 4^{th} serving cell and the X field with X4=1, which indicates that there is additional MPE report for the 4^{th} serving cell. P0=1 and P-MPR0=xx, indicating that the resource ID corresponding to resource index 0 is reported. P1=1 and P-MPR1=xx, indicating that the resource ID corresponding to resource index1 is reported. However, P2=0 and P-MPR2=00, indicating that no other values of P, P-MPR, or resource IDs are reported for the cell.

In this way, for example, the UE does not need to read any additional fields to those containing reported values. Thus, the MAC CE configuration in example 902 may be used, in which the P-MPR3 field is omitted. The P-MPR0 field may be shifted to the right within octet 920, leaving a field of reserve bits R in the octet 920, which may be left reserved or used for some other purpose. The P-MPR1 field and the resource index0 field may be included in the following octet 922, and the P-PMR2 field and the resource index1 field may be included in the octet 924, below the octet 922, as shown.

As indicated above, FIGS. 9A and 9B are provided as examples. Other examples may differ from what is described with regard to FIGS. 9A and 9B. In some aspects, when the UE determines to report two sets of {P, P-MPR, and resource ID} in an additional MPE report in a PHR report for a serving cell, the UE may report the sets of {P0, P-MPR0, resource ID 0} and {P1, P-MPR1, resource ID 1} in corresponding fields to indicate the additional MPE information, and also set the indication of {P2, P-MPR2} with a combination of specified values in corresponding fields to indicate that there is no further resource IDs and P-MPR values are reported in the additional MPE information for the serving cell. In some aspects, when the UE determines to report two sets of {P, P-MPR, and resource ID} in an additional MPE report in a PHR report for a serving cell, the UE may report the sets of {P0=1, P-MPR0, resource ID0} and {P1=1, P-MPR1, resource ID1} in corresponding fields to indicate the additional MPE information, and also set the indication of {P2=0, P-MPR2=00} with a combination of specified values in corresponding fields to indicate that there is no further resource IDs and P-MPR values are reported in the additional MPE information for the serving cell

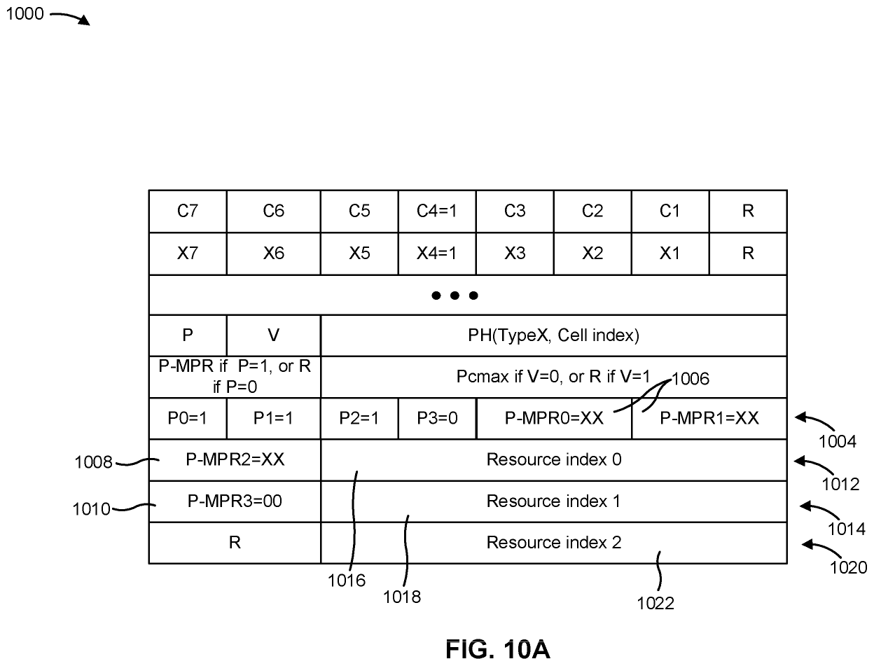

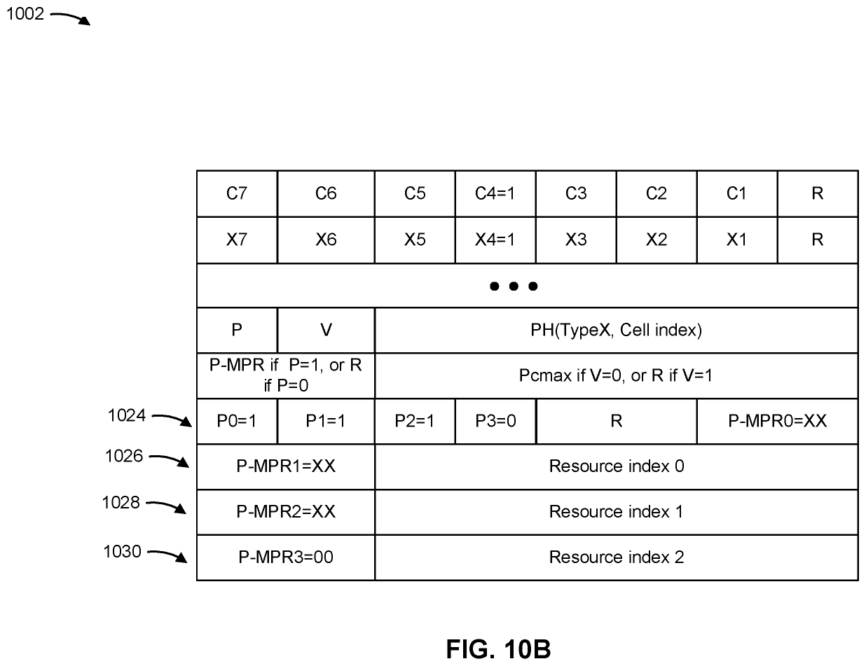

FIGS. 10A and 10B are diagrams illustrating examples 1000 and 1002 of a MAC CE having a PHR, in accordance with the present disclosure. Examples 1000 and 1002 also are associated with aspects described above, in connection with FIG. 6, in which, if a pair of {Pn, P-MPRn} is indicated as a combination of specified values, the nth resource ID and resource IDs having indexes greater than n are not reported, as in examples 900 and 902. In examples 1000 and 1002, the UE reports three reference signals (e.g., three beams are reported via three resource IDs).

As shown in FIG. 10A, for example, the octet 1004 containing the P fields may include the number of P fields being reported and any remaining bits may be allocated to the first two P-MPR fields 1006. The remaining P-MPR fields 1008 and 1010 reported may be included, respectively, in the octet 1012 below the octet 1004 and the octet 1014, below the octet 1012. The octets 1012 and 1014 also may include the resource index fields 1016 and 1018 for the first two resource IDs being reported, respectively. The octet 1020, below the octet 1014, may include the resource index2 field 1022, for the third resource ID being reported. As shown, the remaining bits in the octet 1020 may be reserve bits R.

As shown, the cell index C4=1 indicates that there is a PHR reported for the 4^{th} serving cell, and the X field with X4=1, which indicates that for 4^{th} serving cell there is an additional MPE report in the PHR. P0=1 and P-MPR0=xx, indicating that the resource ID corresponding to resource index 0 is reported. P1=1 and P-MPR1=xx, indicating that the resource ID corresponding to resource index1 is reported. P2=1 and P-MPR2=xx, indicating that the resource ID corresponding to resource index2 is reported. However, P3=0 and P-MPR3=00, indicating that no other values of P, P-MPR, or resource IDs are reported for the cell.

In this way, for example, the UE does not need to read any additional fields to those containing reported values. Thus, the MAC CE configuration in example 1002 may be used, in which the P-MPR3 field is omitted. The P-MPR0 field may be shifted to the right within octet 1024, leaving a field of reserve bits R in the octet 1024, which may be left reserved or used for some other purpose. The P-MPR1 field and the resource index0 field may be included in the following octet 1026, below the octet 1024, and the P-PMR2 field and the resource index1 field may be included in the octet 1028, below the octet 1026, as shown. The resource index2 field may be included in an octet 1030, below the octet 1028. The octet 1030 also may include reserve bits R, as shown.

As indicated above, FIGS. 10A and 10B are provided as examples. Other examples may differ from what is described with regard to FIGS. 10A and 10B. In some aspects, when the UE determines to report three sets of {P, P-MPR, resource ID} in an additional MPE report in a PHR report for a serving cell, the UE may report the sets of {P0, P-MPR0, resource ID 0}, {P1, P-MPR1, resource ID1}, and {P2, P-MPR2, resource ID2} in corresponding fields to indicate the additional MPE information, and also set the indication of {P3, P-MPR3} with a combination of specified (special) values in corresponding fields to indicate that there is no further resource IDs and P-MPR values are reported in the additional MPE information for the serving cell. In some aspects, when the UE determines to report three sets of {P, P-MPR, resource ID} in an additional MPE report in a PHR report for a serving cell, the UE may report the sets of {P0=1, P-MPR0, resource ID0}, {P1=1, P-MPR1, resource ID1}, and {P2=1, P-MPR2, resource ID2} in corresponding fields to indicate the additional MPE information, and also report the indication of {P3=0, P-MPR3-00} with a combination of specified values in corresponding fields to indicate that there is no further resource IDs and P-MPR values are reported in the additional MPE information for the serving cell.

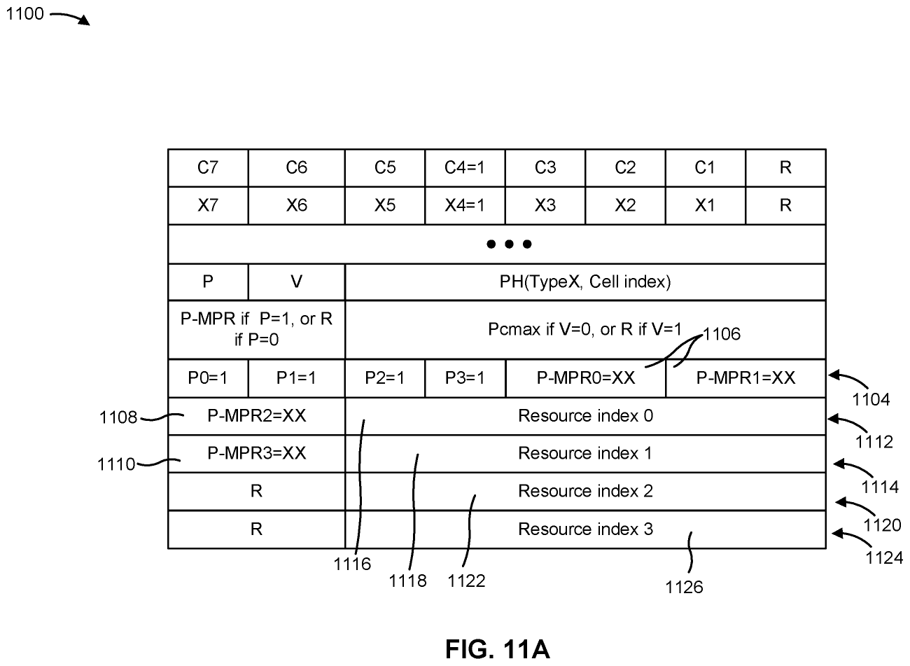

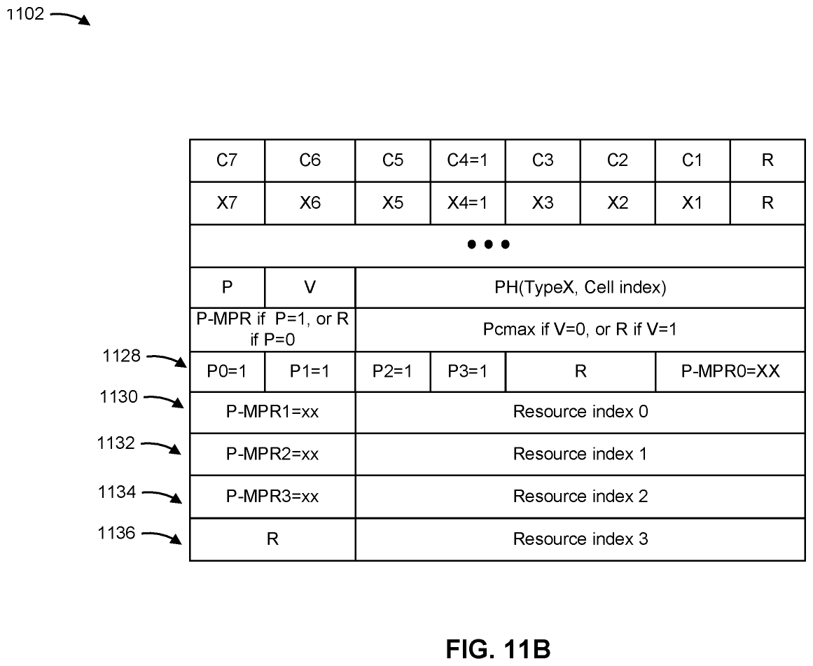

FIGS. 11A and 11B are diagrams illustrating examples 1100 and 1102 of a MAC CE having a PHR, in accordance with the present disclosure. Examples 1100 and 1102 also are associated with aspects described above, in connection with FIG. 6, in which, if a pair of {Pn, P-MPRn} is indicated as a combination of specified values, the nth resource ID and resource IDs having indexes equal to and/or greater than n are not reported, as in examples 1000 and 1002. In examples 1100 and 1102, the UE reports three reference signals (e.g., three beams are reported via three resource IDs).

As shown in FIG. 11A, for example, the octet 1104 containing the P fields may include the number of P fields being reported and any remaining bits may be allocated to the first two P-MPR fields 1106. The remaining P-MPR fields 1108 and 1110 reported may be included, respectively, in the octet 1112 below the octet 1104 and the octet 1114, below the octet 1112. The octets 1112 and 1114 also may include the resource index fields 1116 and 1118 for the first two resource IDs being reported, respectively. The octet 1120, below the octet 1114, may include the resource index2 field 1122, for the third resource ID being reported and the octet 1124, below the octet 1120, may include the resource index3 field, 1126 for the fourth resource ID being reported. As shown, the remaining bits in the octet 1120 and the octet 1124 may be reserve bits R.

As shown, the cell index C4=1 indicates that there is a PHR reported for the 4^{th} serving cell, and the X field with X4=1, which indicates that for 4^{th} serving cell there is an additional MPE report. P0=1 and P-MPR0=xx, indicating that the resource ID corresponding to resource index0 is reported. P1=1 and P-MPR1=xx, indicating that the resource ID corresponding to resource index1 is reported. P2=1 and P-MPR2=xx, indicating that the resource ID corresponding to resource index2 is reported. P3=1 and P-MPR3=xx, indicating that the resource ID corresponding to resource index3 is reported.

The MAC CE configuration in example 1102 includes an alternative configuration, in which the P P-MPR0 field may be shifted to the right within octet 1128, leaving a field of reserve bits R in the octet 1128, which may be left reserved or used for some other purpose. The P-MPR1 field and the resource index0 field may be included in the following octet 1130, below the octet 1128, and the P-PMR2 field and the resource index1 field may be included in the octet 1132, below the octet 1130, as shown. The resource index2 field may be included in an octet 1134, below the octet 1132, and the resource index3 field may be included in an octet 1136, below the octet 1134. The octet 1134 also may include reserve bits R, as shown.

As indicated above, FIGS. 11A and 11B are provided as examples. Other examples may differ from what is described with regard to FIGS. 11A and 11B. In some aspects, when the UE determines to report four sets of {P, P-MPR, resource ID} in an additional MPE report in a PHR report for a serving cell, the UE may report the sets of {P0, P-MPR0, resource ID0}, {P1, P-MPR1, resource ID1}, {P2, P-MPR2, resource ID2}, and {P3, P-MPR3, resource ID3} in corresponding fields to indicate the additional MPE information.

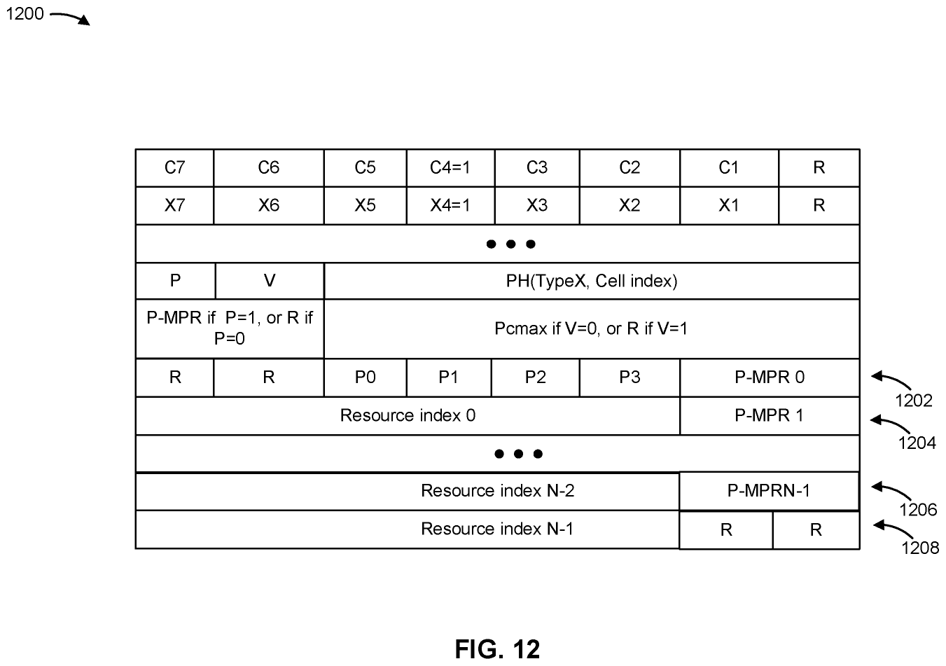

FIG. 12 is a diagram illustrating an example 1200 of a MAC CE having a PHR, in accordance with the present disclosure. Example 1200 also is associated with aspects described above, in connection with FIG. 6, in which, if a pair of {Pn, P-MPRn} is indicated as a combination of specified values, the nth resource ID and resource IDs having indexes equal to and/or greater than n are not reported, as in examples 1100 and 1102. In example 1200, the UE reports N reference signals (e.g., N beams are reported via N resource IDs).

As shown in FIG. 12, for example, the octet 1202 containing the P fields may include the number of P fields being reported and any remaining bits may be allocated as reserve bits R. The octet 1202 also may include the P-MPR0 field. The octet 1204, below the octet 1202, may include the resource index0 and the P-MPR1 field. In some aspects, only if the combination of values of {P0, P-MPR0} indicates that the corresponding resource ID0 is being reported, the octet 1204 may be included (e.g., present) in the MAC-CE to indicate the resource ID0 and the value of P-MPR 1. Similarly, the octet 1206 may include the resource index N−2 and the P-MPR N−1 field. In some aspects, only if the combination of values of {PN-2, P-MPRN-2} indicates that the corresponding resource ID N−1 is being reported, the octet 1206 may be included (e.g., present) in the MAC-CE to indicate the resource ID N−2 and the value of P-MPR N−1. The octet 1208, below the octet 1206, may include the resource indexN−1, with the remaining bits being reserved R. In some aspects, the octet 1208 may be included only if the combination of values of {PN−1, P-MPRN−1} indicates that the corresponding resource ID is being reported.

As indicated above, FIG. 12 is provided as an example. Other examples may differ from what is described with regard to FIG. 12.

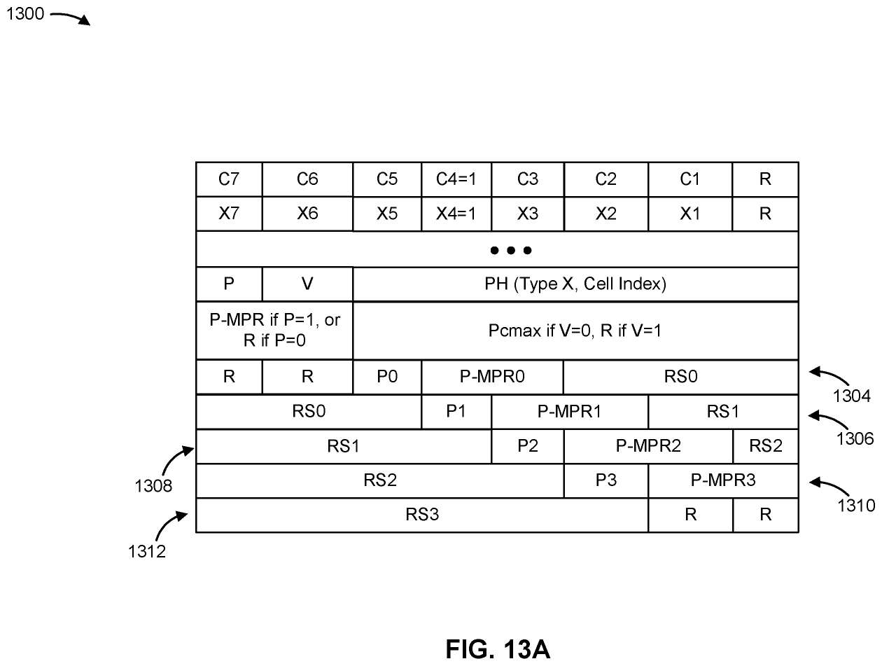

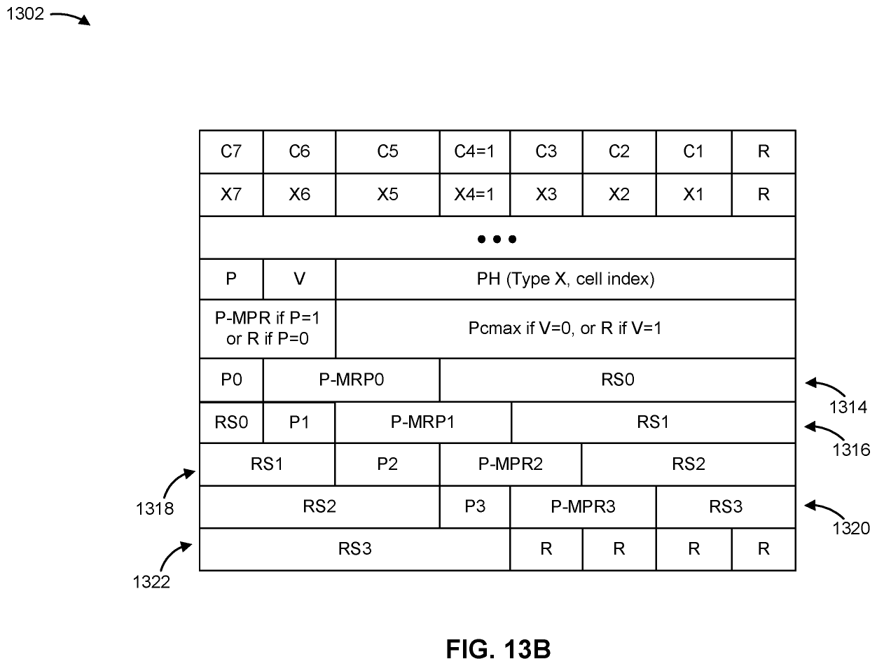

FIGS. 13A and 13B are diagrams illustrating examples 1300 and 1302 of a MAC CE having a PHR, in accordance with the present disclosure. Examples 1300 and 1302 also are associated with aspects described above, in connection with FIG. 6, in which, if a pair of {Pn, P-MPRn} is indicated as a combination of specified values, the nth resource ID and resource IDs having indexes equal to and/or greater than n are not reported, as in example 1200. In examples 1300 and 1302, the UE reports four reference signals (e.g., four beams are reported via four resource IDs). Examples 1300 and 1302 show two different permutations of the MAC CE configuration.

As shown in FIG. 13A, for example, an octet 1304 may contain, from left to right, two reserved bits R, the P0 field, the P-MPR0 field, and a first portion of the resource index0 field (shown as “RS0”). The portion of the RS0 field may include, for example, five bits. An octet 1306, below the octet 1304, may contain, from left to right, a second portion of the RS0 field (e.g., one bit), the P1 field, the P-MPR1 field, and a first portion of the resource index1 field (shown as “RS1”). The first portion of the RS1 field may include, for example, four bits. An octet 1308, below the octet 1306, may contain, from left to right, a second portion of the RS1 field (e.g., two bits), the P2 field, the P-MPR2 field, and a first portion of the resource index2 field (shown as “RS2”). The first portion of the RS2 field may include, for example, three bits. An octet 1310, below the octet 1308, may contain, from left to right, a second portion of the RS2 field (e.g., three bits), the P3 field, the P-MPR3 field, and a first portion of the resource index3 field (shown as “RS3”). The first portion of the RS3 field may include, for example, two bits. An octet 1312, below the octet 1310, may contain, from left to right, a second portion of the RS3 field (e.g., four bits) and two reserve bits R.

As shown in FIG. 13B, for example, an octet 1314 may contain, from left to right, the P0 field, the P-MPR0 field, and a first portion of the resource index0 field (shown as “RS0”). The first portion of the RS0 field may include, for example, five bits. An octet 1316, below the octet 1314, may contain, from left to right, a second portion of the RS0 field (e.g., one bit), the P1 field, the P-MPR1 field, and a first portion of the resource index1 field (shown as “RS1”). The first portion of the RS1 field may include, for example, four bits. An octet 1318, below the octet 1316, may contain, from left to right, a second portion of the RS1 field (e.g., two bits), the P2 field, the P-MPR2 field, and a first portion of the resource index2 field (shown as “RS2”). The first portion of the RS2 field may include, for example, three bits. An octet 1320, below the octet 1318, may contain, from left to right, a second portion of the RS2 field (e.g., three bits), the P3 field, the P-MPR3 field, and a first portion of the resource index3 field (shown as “RS3”). The first portion of the RS3 field may include, for example, two bits. An octet 1322, below the octet 1320, may contain, from left to right, a second portion of the RS3 field (e.g., four bits) and four reserve bits R.

As indicated above, FIGS. 13A and 13B are provided as examples. Other examples may differ from what is described with regard to FIGS. 13A and 13B.

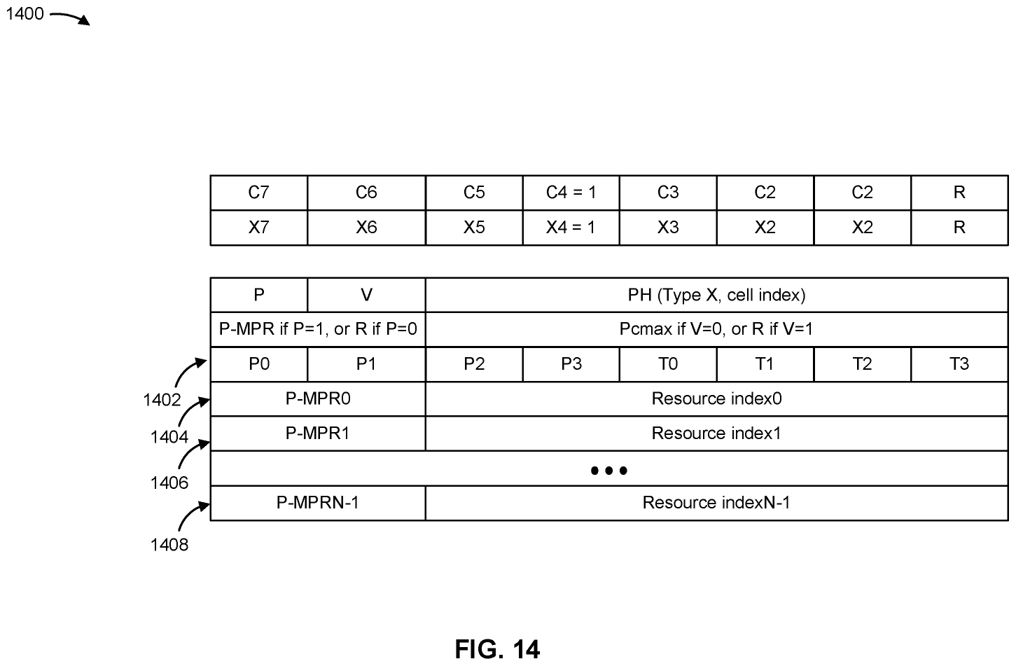

FIG. 14 is a diagram illustrating an example 1400 of a MAC CE having a PHR, in accordance with the present disclosure. Example 1400 is associated with aspects described above, in connection with FIG. 6, in which if a dedicated indication field, that indicates a dedicated indication value, Tn, indicates a specified value (e.g., Tn=0), the nth P-MPR and the nth resource ID are not reported.

As shown, an octet 1402 includes four P fields (P0, P1, P2, and P3) and four corresponding T fields (T0, T1, T2, and T3). Each of the T fields indicates a value of Tn corresponding to the indicated index. As shown, since X4=1, the additional MPE report is reported in the PHR for the 4^{th} serving cell. The resource IDs may be reported via a 1:1 mapping from Tn (where Tn=1) to resource index n. An octet 1404, below octet 1402, includes the P-MPR0 field and the resource index0 field. An octet 1406, below octet 1404, includes the P-MPR1 field and the resource index1 field. Similarly, an octet 1408 includes the P-MPRN−1 field and the resource indexN−1 field. For example, if the field Tn is set to 1, the octet for the P-MPRn field and the resource index n field is not present.

As indicated above, FIG. 14 is provided as an example. Other examples may differ from what is described with regard to FIG. 14.

FIG. 15 is a diagram illustrating an example process 1500 performed, for example, by a user equipment (UE), in accordance with the present disclosure. Example process 1500 is an example where the UE (e.g., UE 602) performs operations associated with techniques for reporting multiple parameter values in a PHR.

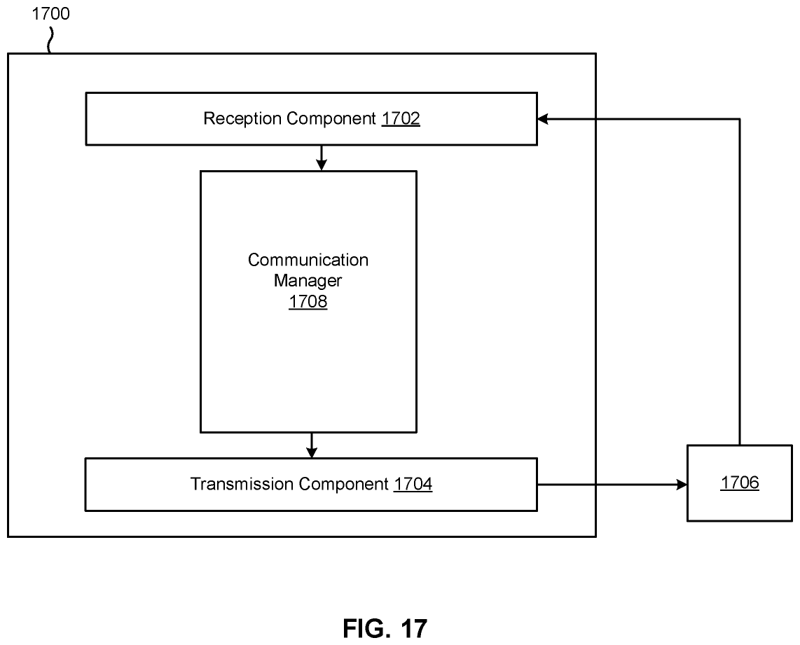

As shown in FIG. 15, in some aspects, process 1500 may include receiving a MPE reporting configuration (block 1510). For example, the UE (e.g., using communication manager 1708 and/or reception component 1702, depicted in FIG. 17) may receive a MPE reporting configuration, as described above.

As further shown in FIG. 15, in some aspects, process 1500 may include transmitting, based at least in part on the MPE reporting configuration, a MAC CE that includes a PHR corresponding to an activated component carrier, the PHR comprising at least one MPE reporting indication that that indicates at least one MPE value, and at least one additional reporting indication that indicates a number of resource IDs reported in the PHR and a number of additional MPE values reported in the PHR, wherein the additional MPE values are associated with the resource IDs (block 1520). For example, the UE (e.g., using communication manager 1708 and/or transmission component 1704, depicted in FIG. 17) may transmit, based at least in part on the MPE reporting configuration, a MAC CE that includes a PHR corresponding to an activated component carrier, the PHR comprising at least one MPE reporting indication that that indicates at least one MPE value, and at least one additional reporting indication that indicates a number of resource IDs reported in the PHR and a number of additional MPE values reported in the PHR, wherein the additional MPE values are associated with the resource IDs, as described above.

Process 1500 may include additional aspects, such as any single aspect or any combination of aspects described below and/or in connection with one or more other processes described elsewhere herein.

In a first aspect, the PHR further comprises a plurality of fields indicating one or more sets of parameter values, wherein a set of parameter values of the one or more sets of parameter values comprises a power management-maximum power reduction (P-MPR) value. In a second aspect, alone or in combination with the first aspect, the at least one additional indication comprises a power backoff indication, of a set of power backoff indications. In a third aspect, alone or in combination with the second aspect, the power backoff indication corresponds to a power management-maximum power reduction (P-MPR) value.

In a fourth aspect, alone or in combination with one or more of the second through third aspects, a value of the power backoff indication is a first specified value of a plurality of specified values, and the PHR does not include a resource ID corresponding to the power backoff indication based at least in part on the value of the power backoff indication being the first specified value. In a fifth aspect, alone or in combination with the fourth aspect, the power backoff indication corresponds to a first index value of a set of index values associated with the one or more sets of parameter values, and the PHR, based at least in part on the value of the power backoff indication being the first specified value, does not include a resource ID corresponding to a second index value, of the set of index values, that is greater than the first index value.

In a sixth aspect, alone or in combination with one or more of the second through fifth aspects, a value of the power backoff indication is a second specified value of a plurality of specified values, the plurality of specified values comprising a first specified value and the second specified value, and the PHR includes a resource ID corresponding to the power backoff indication based at least in part on the value of the power backoff indication being the second specified value. In a seventh aspect, alone or in combination with one or more of the sixth aspect, the PHR indicates a power backoff indication vector comprising the power backoff indication, and a number of power backoff indications in the power backoff indication vector indicates the number of resource IDs reported in the PHR.

In an eighth aspect, alone or in combination with one or more of the first or second aspects, the at least one additional indication comprises an indication pair of a set of indication pairs, the indication pair comprises a power backoff indication and a power management-maximum power reduction (P-MPR) value, and the power backoff indication corresponds to the P-MPR value. In a ninth aspect, alone or in combination with the eighth aspect, a value pair of the indication pair is a combination of a first specified value, of a first plurality of specified values, and a second specified value, of a second plurality of specified values, and the PHR does not include a resource ID corresponding to the P-MPR value based at least in part on the value pair being the combination of the first specified value and the second specified value.

In a tenth aspect, alone or in combination with the ninth aspect, the value pair corresponds to a first index value of a set of index values associated with the one or more sets of parameter values, and the PHR, based at least in part on the value pair not being a combination of the first specified value and the second specified value, does not include a resource ID corresponding to a second index value, of the set of index values, that is greater than the first index value.

In an eleventh aspect, alone or in combination with one or more of the eighth through tenth aspects, a value pair of the indication pair is a combination of a first value that is not a first specified value of a first plurality of specified values, and a second value that is not a second specified value of a second plurality of specified values, and the PHR includes a resource ID corresponding to the P-MPR value based at least in part on the value pair not being a combination of the first specified value and the second specified value. In a twelfth aspect, alone or in combination with the eleventh aspect, a number of indication pairs in the set of indication pairs indicates the number of resource IDs reported in the PHR. In a thirteenth aspect, alone or in combination with the twelfth aspect, the number of resource IDs reported in the PHR is one less than the number of indication pairs in the set of indication pairs.

In a fourteenth aspect, alone or in combination with one or more of the first or second aspects, the at least one additional indication comprises a value of a dedicated indication field. In a fifteenth aspect, alone or in combination with the fourteenth aspect, the dedicated indication field corresponds to a power management-maximum power reduction (P-MPR) value. In a sixteenth aspect, alone or in combination with one or more of the first through fifteenth aspects, a value of the dedicated indication field is a first specified value of a plurality of specified values, and the PHR does not include a resource ID corresponding to the dedicated indication field based at least in part on the value of the dedicated indication field being the first specified value.

In a seventeenth aspect, alone or in combination with one or more of the fifteenth through sixteenth aspects, a value of the dedicated indication field is a second specified value of a plurality of specified values, the plurality of specified values comprising a first specified value and the second specified value, and the PHR includes a resource ID corresponding to the dedicated indication field value based at least in part on the value of the dedicated indication field being the second specified value. In an eighteenth aspect, alone or in combination with the seventeenth aspect, the PHR indicates a dedicated indication vector comprising the value of the dedicated indication field, and a number of dedicated indications in the dedicated indication vector indicates the number of resource IDs reported in the PHR.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a network node, in accordance with the present disclosure. Example process 1600 is an example where the network node (e.g., network node 604) performs operations associated with techniques for reporting multiple parameter values in a PHR.

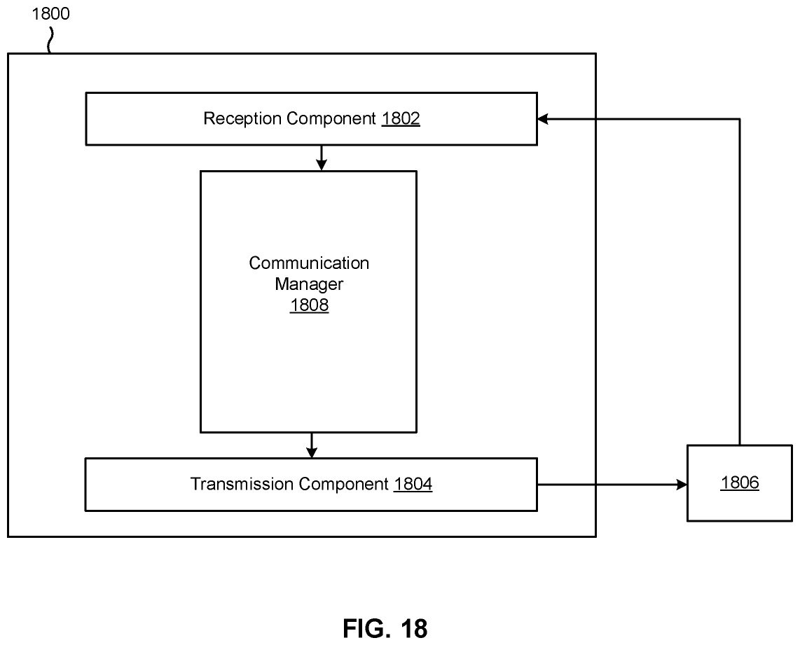

As shown in FIG. 16, in some aspects, process 1600 may include transmitting a MPE reporting configuration (block 1610). For example, the network node (e.g., using communication manager 1808 and/or transmission component 1804, depicted in FIG. 18) may transmit a MPE reporting configuration, as described above.

As further shown in FIG. 16, in some aspects, process 1600 may include receiving, based at least in part on the MPE reporting configuration, a MAC CE that includes a PHR corresponding to an activated component carrier, the PHR comprising at least one MPE reporting indication that that indicates at least one MPE value, and at least one additional reporting indication that indicates a number of resource IDs reported in the PHR and a number of additional MPE values reported in the PHR, wherein the additional MPE values are associated with the resource IDs (block 1620). For example, the network node (e.g., using communication manager 1808 and/or reception component 1802, depicted in FIG. 18) may receive, based at least in part on the MPE reporting configuration, a MAC CE that includes a PHR corresponding to an activated component carrier, the PHR comprising at least one MPE reporting indication that that indicates at least one MPE value, and at least one additional reporting indication that indicates a number of resource IDs reported in the PHR and a number of additional MPE values reported in the PHR, wherein the additional MPE values are associated with the resource IDs, as described above.

Process 1600 may include additional aspects, such as any single aspect or any combination of aspects described below and/or in connection with one or more other processes described elsewhere herein.

In a first aspect, the PHR further comprises a plurality of fields indicating one or more sets of parameter values, wherein a set of parameter values of the one or more sets of parameter values comprises a power management-maximum power reduction (P-MPR) value. In a second aspect, alone or in combination with the first aspect, the at least one additional indication comprises a power backoff indication, of a set of power backoff indications. In a third aspect, alone or in combination with the second aspect, the power backoff indication corresponds to a P-MPR value.

In a fourth aspect, alone or in combination with one or more of the second through third aspects, a value of the power backoff indication is a first specified value of a plurality of specified values, and the PHR does not include a resource ID corresponding to the power backoff indication based at least in part on the value of the power backoff indication being the first specified value. In a fifth aspect, alone or in combination with the fourth aspects, the power backoff indication corresponds to a first index value of a set of index values associated with the one or more sets of parameter values, and the PHR, based at least in part on the value of the power backoff indication being the first specified value, does not include a resource ID corresponding to a second index value, of the set of index values, that is greater than the first index value.

In a sixth aspect, alone or in combination with one or more of the second through fifth aspects, a value of the power backoff indication is a second specified value of a plurality of specified values, the plurality of specified values comprising a first specified value and the second specified value, and the PHR includes a resource ID corresponding to the power backoff indication based at least in part on the value of the power backoff indication being the second specified value. In a seventh aspect, alone or in combination with the sixth aspect, the PHR indicates a power backoff indication vector comprising the power backoff indication, and a number of power backoff indications in the power backoff indication vector indicates the number of resource IDs reported in the PHR.

In an eighth aspect, alone or in combination with one or more of the first or second aspects, the at least one additional indication comprises an indication pair of a set of indication pairs, the indication pair comprises a power backoff indication and a power management-maximum power reduction (P-MPR) value, and the power backoff indication corresponds to the P-MPR value. In a ninth aspect, alone or in combination with the eighth aspects, a value pair of the indication pair is a combination of a first specified value, of a first plurality of specified values, and a second specified value, of a second plurality of specified values, and the PHR does not include a resource ID corresponding to the P-MPR value based at least in part on the value pair being the combination of the first specified value and the second specified value. In a tenth aspect, alone or in combination with the ninth aspect, the value pair corresponds to a first index value of a set of index values associated with the one or more sets of parameter values, and the PHR, based at least in part on the value pair not being a combination of the first specified value and the second specified value, does not include a resource ID corresponding to a second index value, of the set of index values, that is greater than the first index value.

In an eleventh aspect, alone or in combination with one or more of the seventh through tenth aspects, a value pair of the indication pair is a combination of a first value that is not a first specified value of a first plurality of specified values, and a second value that is not a second specified value of a second plurality of specified values, and the PHR includes a resource ID corresponding to the P-MPR value based at least in part on the value pair not being a combination of the first specified value and the second specified value. In a twelfth aspect, alone or in combination with one or more of the first through eleventh aspects, a number of indication pairs in the set of indication pairs indicates the number of resource IDs reported in the PHR. In a thirteenth aspect, alone or in combination with the twelfth aspect, the number of resource IDs reported in the PHR is one less than the number of indication pairs in the set of indication pairs.

In a fourteenth aspect, alone or in combination with one or more of the first or second aspects, the at least one additional indication comprises a value of a dedicated indication field. In a fifteenth aspect, alone or in combination with the fourteenth aspect, the dedicated indication field corresponds to a P-MPR value. In a sixteenth aspect, alone or in combination with the fifteenth aspect, a value of the dedicated indication field is a first specified value of a plurality of specified values, and the PHR does not include a resource ID corresponding to the dedicated indication field based at least in part on the value of the dedicated indication field being the first specified value. In a seventeenth aspect, alone or in combination with one or more of the fifteenth through sixteenth aspects, a value of the dedicated indication field is a second specified value of a plurality of specified values, the plurality of specified values comprising a first specified value and the second specified value, and the PHR includes a resource ID corresponding to the dedicated indication field value based at least in part on the value of the dedicated indication field being the second specified value. In an eighteenth aspect, alone or in combination with the seventeenth aspect, the PHR indicates a dedicated indication vector comprising the value of the dedicated indication field, and a number of dedicated indications in the dedicated indication vector indicates the number of resource IDs reported in the PHR.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication. The apparatus 1700 may be a UE, or a UE may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 1708, which may be, be similar to, include, or be included in, the communication manager 140 depicted in FIGS. 1 and 2.

In some aspects, the apparatus 1700 may be configured to perform one or more operations described herein in connection with FIGS. 6-14B. Additionally, or alternatively, the apparatus 1700 may be configured to perform one or more processes described herein, such as process 1500 of FIG. 15. In some aspects, the apparatus 1700 and/or one or more components shown in FIG. 17 may include one or more components of the UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the UE described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the UE described in connection with FIG. 2. In some aspects, the transmission component 1704 may be co-located with the reception component 1702 in a transceiver.

The communication manager 1708 and/or reception component 1702 may receive a MPE reporting configuration. The communication manager 1708 and/or transmission component 1704 may transmit, based at least in part on the MPE reporting configuration, a MAC CE that includes a PHR corresponding to an activated component carrier, the PHR comprising at least one MPE reporting indication that that indicates at least one MPE value, and at least one additional reporting indication that indicates a number of resource IDs reported in the PHR and a number of additional MPE values reported in the PHR, wherein the additional MPE values are associated with the resource IDs. In some aspects, the communication manager 1708 may include one or more antennas, a modem, a controller/processor, a memory, or a combination thereof, of the UE described in connection with FIG. 2. In some aspects, the communication manager 1708 may include the reception component 1702 and/or the transmission component 1704.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication. The apparatus 1800 may be a network node, or a network node may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804. As further shown, the apparatus 1800 may include a communication manager 1808, which may be, be similar to, include, or be included in, the communication manager 150 depicted in FIGS. 1 and 2.

In some aspects, the apparatus 1800 may be configured to perform one or more operations described herein in connection with FIGS. 6-14B. Additionally, or alternatively, the apparatus 1800 may be configured to perform one or more processes described herein, such as process 1600 of FIG. 16. In some aspects, the apparatus 1800 and/or one or more components shown in FIG. 18 may include one or more components of the UE and/or the base station described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the UE and/or the base station described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the UE and/or the base station described in connection with FIG. 2. In some aspects, the transmission component 1804 may be co-located with the reception component 1802 in a transceiver.

The communication manager 1808 and/or the transmission component 1804 may transmit a MPE reporting configuration. The communication manager 1808 and/or the reception component 1802 may receive, based at least in part on the MPE reporting configuration, a MAC CE that includes a PHR corresponding to an activated component carrier, the PHR comprising at least one MPE reporting indication that that indicates at least one MPE value, and at least one additional reporting indication that indicates a number of resource IDs reported in the PHR and a number of additional MPE values reported in the PHR, wherein the additional MPE values are associated with the resource IDs. In some aspects, the communication manager 1808 may include one or more antennas, a modem, a controller/processor, a memory, or a combination thereof, of the UE and/or the base station described in connection with FIG. 2. In some aspects, the communication manager 1808 may include the reception component 1802 and/or the transmission component 1804.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The following provides an overview of some Aspects of the present disclosure:
Aspect 1: A method of wireless communication performed by a user equipment (UE), comprising: receiving a maximum permitted exposure (MPE) reporting configuration; and transmitting, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.
Aspect 2: The method of Aspect 1, wherein the PHR further comprises a plurality of fields indicating one or more sets of parameter values, wherein a set of parameter values of the one or more sets of parameter values comprises a power management-maximum power reduction (P-MPR) value.
Aspect 3: The method of either of Aspects 1 or 2, wherein the at least one additional indication comprises a power backoff indication, of a set of power backoff indications.
Aspect 4: The method of Aspect 3, wherein the power backoff indication corresponds to a power management-maximum power reduction (P-MPR) value.
Aspect 5: The method of either of Aspects 3 or 4, wherein a value of the power backoff indication is a first specified value of a plurality of specified values, and wherein the PHR does not include a resource ID corresponding to the power backoff indication based at least in part on the value of the power backoff indication being the first specified value.
Aspect 6: The method of Aspect 5, wherein the power backoff indication corresponds to a first index value of a set of index values associated with the one or more sets of parameter values, and wherein the PHR, based at least in part on the value of the power backoff indication being the first specified value, does not include a resource ID corresponding to a second index value, of the set of index values, that is greater than the first index value.
Aspect 7: The method of any of Aspects 3-6, wherein a value of the power backoff indication is a second specified value of a plurality of specified values, the plurality of specified values comprising a first specified value and the second specified value, and wherein the PHR includes a resource ID corresponding to the power backoff indication based at least in part on the value of the power backoff indication being the second specified value.
Aspect 8: The method of Aspect 7, wherein the PHR indicates a power backoff indication vector comprising the power backoff indication, and wherein a number of power backoff indications in the power backoff indication vector indicates the number of resource IDs reported in the PHR.
Aspect 9: The method of either of Aspects 1 or 2, wherein the at least one additional indication comprises an indication pair of a set of indication pairs, wherein the indication pair comprises a power backoff indication and a power management-maximum power reduction (P-MPR) value, wherein the power backoff indication corresponds to the P-MPR value.
Aspect 10: The method of Aspect 9, wherein a value pair of the indication pair is a combination of a first specified value, of a first plurality of specified values, and a second specified value, of a second plurality of specified values, and wherein the PHR does not include a resource ID corresponding to the P-MPR value based at least in part on the value pair being the combination of the first specified value and the second specified value.
Aspect 11: The method of Aspect 10, wherein the value pair corresponds to a first index value of a set of index values associated with the one or more sets of parameter values, and wherein the PHR, based at least in part on the value pair not being a combination of the first specified value and the second specified value, does not include a resource ID corresponding to a second index value, of the set of index values, that is greater than the first index value.
Aspect 12: The method of any of Aspects 9-11, wherein a value pair of the indication pair is a combination of a first value that is not a first specified value of a first plurality of specified values, and a second value that is not a second specified value of a second plurality of specified values, and wherein the PHR includes a resource ID corresponding to the P-MPR value based at least in part on the value pair not being a combination of the first specified value and the second specified value.
Aspect 13: The method of Aspect 12, wherein a number of indication pairs in the set of indication pairs indicates the number of resource IDs reported in the PHR.
Aspect 14: The method of Aspect 13, wherein the number of resource IDs reported in the PHR is one less than the number of indication pairs in the set of indication pairs.
Aspect 15: The method of either of Aspects 1 or 2, wherein the at least one additional indication comprises a value of a dedicated indication field.
Aspect 16: The method of Aspect 15, wherein the dedicated indication field corresponds to a power management-maximum power reduction (P-MPR) value.
Aspect 17: The method of Aspect 16, wherein a value of the dedicated indication field is a first specified value of a plurality of specified values, and wherein the PHR does not include a resource ID corresponding to the dedicated indication field based at least in part on the value of the dedicated indication field being the first specified value.
Aspect 18: The method of either of Aspects 16 or 17, wherein a value of the dedicated indication field is a second specified value of a plurality of specified values, the plurality of specified values comprising a first specified value and the second specified value, and wherein the PHR includes a resource ID corresponding to the dedicated indication field value based at least in part on the value of the dedicated indication field being the second specified value.
Aspect 19: The method of Aspect 18, wherein the PHR indicates a dedicated indication vector comprising the value of the dedicated indication field, and wherein a number of dedicated indications in the dedicated indication vector indicates the number of resource IDs reported in the PHR.
Aspect 20: A method of wireless communication performed by a network node, comprising: transmitting a maximum permitted exposure (MPE) reporting configuration; and receiving, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.
Aspect 21: The method of Aspect 20, wherein the PHR further comprises a plurality of fields indicating one or more sets of parameter values, wherein a set of parameter values of the one or more sets of parameter values comprises a power management-maximum power reduction (P-MPR) value.
Aspect 22: The method of either of Aspects 20 or 21, wherein the at least one additional indication comprises a power backoff indication, of a set of power backoff indications.
Aspect 23: The method of Aspect 22, wherein the power backoff indication corresponds to a power management-maximum power reduction (P-MPR) value.
Aspect 24: The method of either of Aspects 22 or 23, wherein a value of the power backoff indication is a first specified value of a plurality of specified values, and wherein the PHR does not include a resource ID corresponding to the power backoff indication based at least in part on the value of the power backoff indication being the first specified value.
Aspect 25: The method of Aspect 24, wherein the power backoff indication corresponds to a first index value of a set of index values associated with the one or more sets of parameter values, and wherein the PHR, based at least in part on the value of the power backoff indication being the first specified value, does not include a resource ID corresponding to a second index value, of the set of index values, that is greater than the first index value.
Aspect 26: The method of any of Aspects 22-25, wherein a value of the power backoff indication is a second specified value of a plurality of specified values, the plurality of specified values comprising a first specified value and the second specified value, and wherein the PHR includes a resource ID corresponding to the power backoff indication based at least in part on the value of the power backoff indication being the second specified value.
Aspect 27: The method of Aspect 26, wherein the PHR indicates a power backoff indication vector comprising the power backoff indication, and wherein a number of power backoff indications in the power backoff indication vector indicates the number of resource IDs reported in the PHR.
Aspect 28: The method of either of Aspects 20 or 21, wherein the at least one additional indication comprises an indication pair of a set of indication pairs, wherein the indication pair comprises a power backoff indication and a power management-maximum power reduction (P-MPR) value, wherein the power backoff indication corresponds to the P-MPR value.
Aspect 29: The method of Aspect 28, wherein a value pair of the indication pair is a combination of a first specified value, of a first plurality of specified values, and a second specified value, of a second plurality of specified values, and wherein the PHR does not include a resource ID corresponding to the P-MPR value based at least in part on the value pair being the combination of the first specified value and the second specified value.
Aspect 30: The method of Aspect 29, wherein the value pair corresponds to a first index value of a set of index values associated with the one or more sets of parameter values, and wherein the PHR, based at least in part on the value pair not being a combination of the first specified value and the second specified value, does not include a resource ID corresponding to a second index value, of the set of index values, that is greater than the first index value.
Aspect 31: The method of any of Aspects 28-30, wherein a value pair of the indication pair is a combination of a first value that is not a first specified value of a first plurality of specified values, and a second value that is not a second specified value of a second plurality of specified values, and wherein the PHR includes a resource ID corresponding to the P-MPR value based at least in part on the value pair not being a combination of the first specified value and the second specified value.
Aspect 32: The method of Aspect 31, wherein a number of indication pairs in the set of indication pairs indicates the number of resource IDs reported in the PHR.
Aspect 33: The method of Aspect 32, wherein the number of resource IDs reported in the PHR is one less than the number of indication pairs in the set of indication pairs.
Aspect 34: The method of either of Aspects 20 or 21, wherein the at least one additional indication comprises a value of a dedicated indication field.
Aspect 35: The method of Aspect 34, wherein the dedicated indication field corresponds to a power management-maximum power reduction (P-MPR) value.
Aspect 36: The method of Aspect 35, wherein a value of the dedicated indication field is a first specified value of a plurality of specified values, and wherein the PHR does not include a resource ID corresponding to the dedicated indication field based at least in part on the value of the dedicated indication field being the first specified value.
Aspect 37: The method of either of Aspects 35 or 36, wherein a value of the dedicated indication field is a second specified value of a plurality of specified values, the plurality of specified values comprising a first specified value and the second specified value, and wherein the PHR includes a resource ID corresponding to the dedicated indication field value based at least in part on the value of the dedicated indication field being the second specified value.
Aspect 38: The method of Aspect 37, wherein the PHR indicates a dedicated indication vector comprising the value of the dedicated indication field, and wherein a number of dedicated indications in the dedicated indication vector indicates the number of resource IDs reported in the PHR.
Aspect 39: An apparatus for wireless communication at a device, comprising a processor; memory coupled with the processor; and instructions stored in the memory and executable by the processor to cause the apparatus to perform the method of one or more of Aspects 1-19.
Aspect 40: A device for wireless communication, comprising a memory and one or more processors coupled to the memory, the one or more processors configured to perform the method of one or more of Aspects 1-19.
Aspect 41: An apparatus for wireless communication, comprising at least one means for performing the method of one or more of Aspects 1-19.
Aspect 42: A non-transitory computer-readable medium storing code for wireless communication, the code comprising instructions executable by a processor to perform the method of one or more of Aspects 1-19.
Aspect 43: A non-transitory computer-readable medium storing a set of instructions for wireless communication, the set of instructions comprising one or more instructions that, when executed by one or more processors of a device, cause the device to perform the method of one or more of Aspects 1-19.
Aspect 44: An apparatus for wireless communication at a device, comprising a processor; memory coupled with the processor; and instructions stored in the memory and executable by the processor to cause the apparatus to perform the method of one or more of Aspects 20-38.
Aspect 45: A device for wireless communication, comprising a memory and one or more processors coupled to the memory, the one or more processors configured to perform the method of one or more of Aspects 20-38.
Aspect 46: An apparatus for wireless communication, comprising at least one means for performing the method of one or more of Aspects 20-38.
Aspect 47: A non-transitory computer-readable medium storing code for wireless communication, the code comprising instructions executable by a processor to perform the method of one or more of Aspects 20-38.
Aspect 48: A non-transitory computer-readable medium storing a set of instructions for wireless communication, the set of instructions comprising one or more instructions that, when executed by one or more processors of a device, cause the device to perform the method of one or more of Aspects 20-38.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving a maximum permitted exposure (MPE) reporting configuration; and
transmitting, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

2. The method of claim 1, wherein the PHR further comprises a plurality of fields indicating one or more sets of parameter values, wherein a set of parameter values of the one or more sets of parameter values comprises a power management-maximum power reduction (P-MPR) value.

3. The method of claim 1, wherein the at least one additional reporting indication comprises a power backoff indication, of a set of power backoff indications.

4. The method of claim 3, wherein the power backoff indication corresponds to a power management-maximum power reduction (P-MPR) value.

5. The method of claim 3, wherein a value of the power backoff indication is a first specified value of a plurality of specified values, and wherein the PHR does not include a resource ID corresponding to the power backoff indication based at least in part on the value of the power backoff indication being the first specified value.

6. The method of claim 5, wherein the power backoff indication corresponds to a first index value of a set of index values associated with one or more sets of parameter values, and wherein the PHR, based at least in part on the value of the power backoff indication being the first specified value, does not include a resource ID corresponding to a second index value, of the set of index values, that is greater than the first index value.

7. The method of claim 3, wherein a value of the power backoff indication is a second specified value of a plurality of specified values, the plurality of specified values comprising a first specified value and the second specified value, and wherein the PHR includes a resource ID corresponding to the power backoff indication based at least in part on the value of the power backoff indication being the second specified value.

8. The method of claim 7, wherein the PHR indicates a power backoff indication vector comprising the power backoff indication, and wherein a number of power backoff indications in the power backoff indication vector indicates the number of resource IDs reported in the PHR.

9. The method of claim 1, wherein the at least one additional reporting indication comprises an indication pair of a set of indication pairs, wherein the indication pair comprises a power backoff indication and a power management-maximum power reduction (P-MPR) value, wherein the power backoff indication corresponds to the P-MPR value.

10. The method of claim 9, wherein a value pair of the indication pair is a combination of a first specified value, of a first plurality of specified values, and a second specified value, of a second plurality of specified values, and wherein the PHR does not include a resource ID corresponding to the P-MPR value based at least in part on the value pair being the combination of the first specified value and the second specified value.

11. The method of claim 10, wherein the value pair corresponds to a first index value of a set of index values associated with one or more sets of parameter values, and wherein the PHR, based at least in part on the value pair not being a combination of the first specified value and the second specified value, does not include a resource ID corresponding to a second index value, of the set of index values, that is greater than the first index value.

12. The method of claim 9, wherein a value pair of the indication pair is a combination of a first value that is not a first specified value of a first plurality of specified values, and a second value that is not a second specified value of a second plurality of specified values, and wherein the PHR includes a resource ID corresponding to the P-MPR value based at least in part on the value pair not being a combination of the first specified value and the second specified value.

13. The method of claim 12, wherein a number of indication pairs in the set of indication pairs indicates the number of resource IDs reported in the PHR.

14. The method of claim 13, wherein the number of resource IDs reported in the PHR is one less than the number of indication pairs in the set of indication pairs.

15. The method of claim 1, wherein the at least one additional reporting indication comprises a value of a dedicated indication field.

16. The method of claim 15, wherein the dedicated indication field corresponds to a power management-maximum power reduction (P-MPR) value.

17. The method of claim 16, wherein a value of the dedicated indication field is a first specified value of a plurality of specified values, and wherein the PHR does not include a resource ID corresponding to the dedicated indication field based at least in part on the value of the dedicated indication field being the first specified value.

18. The method of claim 16, wherein a value of the dedicated indication field is a second specified value of a plurality of specified values, the plurality of specified values comprising a first specified value and the second specified value, and wherein the PHR includes a resource ID corresponding to the value of the dedicated indication field based at least in part on the value of the dedicated indication field being the second specified value.

19. The method of claim 18, wherein the PHR indicates a dedicated indication vector comprising the value of the dedicated indication field, and wherein a number of dedicated indications in the dedicated indication vector indicates the number of resource IDs reported in the PHR.

20. A method of wireless communication performed by a network node, comprising:
transmitting a maximum permitted exposure (MPE) reporting configuration; and
receiving, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

21. The method of claim 20, wherein the PHR further comprises a plurality of fields indicating one or more sets of parameter values, wherein a set of parameter values of the one or more sets of parameter values comprises a power management-maximum power reduction (P-MPR) value.

22. The method of claim 20, wherein the at least one additional reporting indication comprises a power backoff indication, of a set of power backoff indications.

23. The method of claim 22, wherein the power backoff indication corresponds to a power management-maximum power reduction (P-MPR) value.

24. The method of claim 22, wherein a value of the power backoff indication is a first specified value of a plurality of specified values, and wherein the PHR does not include a resource ID corresponding to the power backoff indication based at least in part on the value of the power backoff indication being the first specified value.

25-38. (canceled)

39. A user equipment (UE) for wireless communication, comprising:
one or more memories; and
one or more processors, coupled to the one or more memories, configured to:
receive a maximum permitted exposure (MPE) reporting configuration; and
transmit, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

40. The UE of claim 39, wherein the PHR further comprises a plurality of fields indicating one or more sets of parameter values, wherein a set of parameter values of the one or more sets of parameter values comprises a power management-maximum power reduction (P-MPR) value.

41. The UE of claim 39, wherein the at least one additional reporting indication comprises a power backoff indication, of a set of power backoff indications.

42. The UE of claim 41, wherein the power backoff indication corresponds to a power management-maximum power reduction (P-MPR) value.

43. The UE of claim 41, wherein a value of the power backoff indication is a first specified value of a plurality of specified values, and wherein the PHR does not include a resource ID corresponding to the power backoff indication based at least in part on the value of the power backoff indication being the first specified value.

44-57. (canceled)

58. A network node for wireless communication, comprising:
one or more memories; and
one or more processors, coupled to the one or more memories, configured to:
transmit a maximum permitted exposure (MPE) reporting configuration; and
receive, based at least in part on the MPE reporting configuration, a medium access control (MAC) control element (MAC CE) that includes a power headroom report (PHR) corresponding to an activated component carrier, the PHR comprising at least one MPE reporting indication that that indicates at least one MPE value, and at least one additional reporting indication that indicates a number of resource identifiers (IDs) reported in the PHR and a number of additional MPE values reported in the PHR, wherein the additional MPE values are associated with the resource IDs.

59-152. (canceled)
